(19) United States
(12) Patent Application Publication
(10) Pub. No.: US 2010/0008808 A1
(43) Pub. Date: Jan. 14, 2010

(54) SLIDING FACE MODIFICATION MATERIAL, METHOD FOR PRODUCING SLIDING FACE MODIFICATION MATERIAL, METHOD FOR USING SLIDING FACE MODIFICATION MATERIAL, SLIDING MEMBERS HAVING SLIDING FACE MODIFICATION MATERIAL, AND COMPRESSOR COMPRISING SLIDING MEMBERS

(76) Inventors: Yuuki Yoshimi, Shiga (JP); Yoichiro Nakamura, Shiga (JP); Hirotaka Kawabata, Shiga (JP); Masato Ishiwata, Tokyo (JP); Masato Hinata, Tokyo (JP); Katsuhiro Shikano, Tokyo (JP)

Correspondence Address: WENDEROTH, LIND & PONACK L.L.P., 1030 15th Street, N.W., Suite 400 East, Washington, DC, 20005-1503, US

(21) Appl. No.: 12/445,496

(22) PCT Filed: Oct. 15, 2007
(86) PCT No.: PCT/JP2007/070501

§ 371 Date: Apr. 14, 2009

(30) Foreign Application Priority Data
Oct. 16, 2006 (JP) 2006-281468
Oct. 16, 2006 (JP) 2006-281471

(51) Int. Cl. F04C 29/02; B32B 15/04; B05D 5/08; C10M 125/22; F25B 1/00; F03C 2/00; F04C 2/00

(52) U.S. Cl. 418/63; 427/180; 428/472; 508/167; 508/108; 62/498; 418/83; 418/248

(57) ABSTRACT

A highly reliable sliding face modification material capable of forming a stable film of molybdenum disulfide on the sliding face of a sliding member, the sliding face modification material having a molybdenum disulfide content of 95 wt % or more and an organic material content of 1500 ppm or less in weight ratio, and the sliding face modification material being projected onto the sliding face to form a coating layer.

### TECHNICAL FIELD

The present invention relates to a sliding face modification material for modifying the sliding faces of sliding members, a method for producing the sliding face modification material, a method for using the sliding face modification material, sliding members having the sliding face modification material, and a compressor comprising the sliding members.

### BACKGROUND ART

In recent years, energy-saving electrical appliances have been being developed for the protection of global environment, and energy-saving apparatuses, in which the friction coefficients of the sliding faces of the sliding members thereof are lowered, are provided, for example, for compressors being used for household electric refrigerator-freezers.

In a conventional technology, a method has been disclosed in which the sliding face of a sliding member is modified by projecting molybdenum disulfide thereto to form a surface layer having a low friction coefficient on the sliding face (for example, refer to Japanese Patent No. 3670598). In addition, a compressor has been disclosed in which minute pits are formed nearly uniformly in the sliding face of a sliding member, and oil is supplied to the sliding face and stored in the minute pits so that the friction coefficient between the sliding members become low and the sliding loss is reduced (for example, refer to WO 2004/055371).

Sliding members constituting a conventional compressor will be described below referring to the accompanying drawings.

FIG. 16 is a vertical sectional view showing the configuration of the conventional compressor. FIG. 17 is an enlarged perspective view schematically showing the cross section of a surface layer that is modified by projecting a conventional molybdenum disulfide projecting material.

As shown in FIG. 16, in a hermetically sealed container 1, oil 2 is stored at the bottom thereof, and the hermetically sealed container 1 accommodates an electric driving unit 5 comprising a stator 3 and a rotor 4, and also accommodates a reciprocating compression unit 6 that is driven using this electric driving unit 5. The compression unit 6 compresses a refrigerant introduced into the hermetically sealed container 201 through a suction tube 20.

Next, the compression unit 6 of the conventional compressor configured as described above will be described below.

In the compressor, a crankshaft 7 comprises a main shaft 8 on which the rotor 4 is pressure-fitted so as to be secured thereto and an eccentric shaft 9 formed so as to be eccentric with respect to this main shaft 8. An oil pump 10 is provided at the lower end of the eccentric shaft 9. The eccentric shaft 9 is connected to a piston 15 via a connecting rod 17 serving as a connecting means. A cylinder bore 12 in which the piston 15 reciprocates is formed inside a cylinder block 11. A compression chamber 13, the inner circumferential face of which is defined by the cylinder bore 12 having a nearly cylindrical shape, and a bearing section 14 for journaling the main shaft section 8 are provided for the cylinder block 11.

As described above, in the conventional compressor, the piston 15 loosely fitted in the cylinder bore 12 so as to slide therein is connected to the eccentric shaft 9 via a piston pin 16 and the connecting rod 17. The end face of the cylinder bore 12 inside the cylinder block 11 is sealed with a valve plate 18. In addition, the cylinder head 19 of the cylinder block 11 has a high-pressure chamber (not shown) and a low-pressure chamber (not shown) and is secured to the valve plate 18 on the opposite side (the right side in FIG. 16) of the cylinder block 11.

The suction tube 20 is secured to the hermetically sealed container 1 and connected to the low-pressure side (not shown) of a refrigeration cycle so as to introduce the refrigerant into the hermetically sealed container 1. A suction muffler 21, provided so that the refrigerant introduced into the hermetically sealed container 1 is further introduced into the compression chamber 13, is held between the valve plate 18 and the head 19 and secured.

In the conventional compressor configured as described above, mutually sliding sections are formed between the main shaft 8 of the crankshaft 7 and the bearing section 14, between the piston 15 and the cylinder bore 12, between the piston pin 16 and the connecting rod 17, and between the eccentric shaft 9 of the crankshaft 7 and the connecting rod 17. Furthermore, particles of the molybdenum disulfide projecting material are collided with the surface of one of the mutually sliding sections of the sliding members to form a surface layer 22 (refer to FIG. 17).

Next, the operation of the conventional compressor configured as described above will be described below. When the power from a power supply (not shown) is supplied to the electric driving unit 5, the rotor 4 of the electric driving unit 5 is rotated, and the rotor 4 rotates the crankshaft 7. By the rotation of the crankshaft 7, the eccentric shaft 9 performs eccentric movement, and the eccentric movement is transmitted from the connecting rod 17 serving as a connecting means to the piston 15 via the piston pin 16, thereby reciprocating the piston 15. As a result, the piston 15 reciprocates inside the cylinder bore 12, and the refrigerant introduced into the hermetically sealed container 1 through the suction tube 20 is suctioned through the suction muffler 21 and compressed continuously inside the compression chamber 13.

As the crankshaft 7 is rotated, the oil 2 is supplied from the oil pump 10 to the respective sliding sections of the sliding members to lubricate the sliding sections. In addition, the oil 2 serves as a seal for sealing the clearance between the piston 15 and the cylinder bore 12.

In the compressor, the piston 15 serving as a sliding member is loosely fitted in the cylinder bore 12 while a very small clearance is provided therebetween to reduce leakage loss. As a result, mutually contacting portions are present partially owing to variations in shape and accuracy of the piston 15 and the cylinder bore 12.

However, the surface layer 22 is formed on the sliding face of the piston 15, one of the sliding members. For this reason, even if metal-to-metal contact occurs between the piston 15 and the cylinder bore 12 at the top dead center and the bottom dead center of the piston 15 wherein the speed of the piston 15 is zero, the friction coefficient becomes low owing to the solid lubrication function of the molybdenum disulfide contained in the surface layer 22 formed on the surface of the piston 15, and sliding loss is reduced (refer to Japanese Patent No. 3670598). Furthermore, minute pits 23 are formed in the surface of the sliding section of a sliding member so as to function as labyrinth seals when the refrigerant is compressed, whereby the leakage loss is reduced and the abrasion resistance is improved (refer to WO 2004/055371).

However, a molybdenum disulfide material produced as a mineral and dressed (pulverized and classified) is used as a projecting material on the surface layers of the sliding sections in the conventional compressor. Hence, in addition to molybdenum disulfide, many impurities are contained in the conventional molybdenum disulfide projecting material, and a large amount of organic material is contained in the impurities. The organic material is herein defined as compounds containing C and H, oils, such as hydraulic oil, dust, and dirt. When an attempt was made to form a surface layer by projecting the molybdenum disulfide projecting material described above, variations occurred in the formation state of the surface layer, and a desired film was not formed uniformly on the whole of the sliding face in some cases.

It seems that this problem is caused by the organic material contained as impurities in the molybdenum disulfide projecting material. When the amount of the organic material contained in the conventional molybdenum disulfide projecting material was measured, it was found that the amount of the organic material was 2000 ppm or more in weight ratio.

It seems that in the case that the organic material is contained in the molybdenum disulfide projecting material, when the projecting material is projected, the organic material is first attached to the surface of the sliding section of the sliding member and serves as a cushioning material, and the force of the molybdenum disulfide being collided with the surface of the sliding section is weakened. In addition, it seems that the energy generated at the time of the projection and collision is used for the organic material and for the chemical reaction of the organic material and the projecting material, and the energy for surface modification is reduced.

Furthermore, it seems that if the organic material is physically adsorbed to the molybdenum disulfide projecting material by, for example, attachment thereto, the organic material is desorbed at the time of the projection, whereby the energy is consumed owing to the desorption and the energy for surface modification is reduced.

It is assumed that the organic material is contained in the molybdenum disulfide projecting material because the organic material cannot be removed but remains at the time of the dressing, or because the organic material is contained owing to the attachment of oil mist contained in the atmosphere in the projection process from the charging of the molybdenum disulfide projecting material into a projection apparatus to the actual projection, or the attachment of hydraulic oil, or the mixture of dust and dirt.

Hence, when an attempt was made to form a surface layer by projecting the conventional molybdenum disulfide projecting material containing a large amount of organic material onto the surface of a sliding member of the compressor, variations occurred in the formation state of the surface layer, and a desired friction coefficient was unable to be obtained. As a result, the sliding loss might not be reduced sufficiently.

Furthermore, although the surface layer serving as a sliding face in the above-mentioned conventional compressor is formed by projecting the molybdenum disulfide projecting material onto the surface of the sliding section of a sliding member, the adhesion strength between the surface layer and the surface of the sliding section is low, and the surface layer is apt to be peeled from the base material of the sliding member. As a result, the surface layer serving as a film on a target lubrication face is not formed in some cases.

After examining the sliding members from which the surface layers were peeled, the inventors have found that a chemical reaction layer composed of iron, molybdenum and sulfur is hardly formed between the surface layer of molybdenum disulfide and the sliding section of each sliding member.

It seems that this is because of the existence of impurities contained in the molybdenum disulfide projecting material in addition to the relationship between the projection pressure and the projection amount being used as the conditions for the projection method. Hence, the amount of water contained in the molybdenum disulfide projecting material that was used when the peeling occurred was measured. As the result of the measurement, the amount of water contained in the molybdenum disulfide projecting material was approximately 7500 ppm in weight ratio.

The chemical reaction layer that is formed between the surface layer of molybdenum disulfide and the sliding member is formed when the base material of the sliding member reacts with the particles of the molybdenum disulfide by the aid of the thermal energy generated when the molybdenum disulfide particles are collided with the sliding face of the sliding member made of metal serving as the base material thereof. The chemical reaction layer serves as a binder between the surface layer of molybdenum disulfide and the base material, thereby raising the adhesion strength between the surface layer in which the molybdenum disulfide is solid-dissolved and the sliding member.

However, since the molybdenum disulfide serving as the conventional projecting material is fine powder, it has a property of being apt to absorb water in the outside air. For this reason, it is assumed that if water is contained in the molybdenum disulfide projecting material, the molybdenum disulfide particles are projected in the form of lumps, and that when the lumps are collided with the base material of the sliding member, the energy of the collision is dispersed, and the energy for forming the chemical reaction layer for binding the surface layer with the base material becomes insufficient, whereby the adhesion strength between the surface layer and the base material of the sliding member becomes low and peeling of the surface layer occurs.

When the surface layer was formed on the surface of the sliding member being used for the conventional compressor using the molybdenum disulfide projecting material containing abundant water as described above, peeling of the surface layer occurred, and the friction coefficient of the sliding member was not lowered sufficiently in some cases. As a result, the sliding loss of the sliding member of the conventional compressor was not able to be reduced sufficiently, and the abrasion resistance thereof might be lowered.

### DISCLOSURE OF INVENTION

The present invention is intended to solve the problems encountered in the sliding sections of the sliding members of the conventional compressor described above. Accordingly, objects of the present invention are to provide a sliding face modification material having high reliability and being capable of forming a stable film of molybdenum disulfide on the sliding section of a sliding member; a method for producing the sliding face modification material; a method for using the sliding face modification material so that a stable film of molybdenum disulfide can be formed securely; sliding members modified using the sliding face modification material and having high reliability; and a compressor comprising the sliding members and having high reliability and high efficiency.

In addition, further objects of the present invention are to provide a sliding face modification material capable of forming a coating layer having high adhesion strength between the molybdenum disulfide and the base material of the sliding member and capable of reducing the peeling of the coating layer from the base material of the sliding member by reducing the water content contained in the sliding face modification material; a highly reliable sliding member capable of lowering the friction coefficient of the sliding section thereof by virtue of the solid lubrication function of the formed coating layer and capable of reducing the sliding loss; and a compressor comprising the sliding members and having high reliability and high efficiency.

To attain the above-mentioned objects, a sliding face modification material according to a first aspect of the present invention has a molybdenum disulfide content of 95 wt % or more and an organic material content of 1500 ppm or less in weight ratio, and this sliding face modification material is projected onto a sliding face to form a coating layer. When the sliding face modification material according to the present invention configured as described above is projected onto the surface of the sliding section of a sliding member by applying wind pressure or the like, the probability that the organic material is attached to the surface of the sliding section of the sliding member earlier than the molybdenum disulfide is reduced. Hence, the adverse effect of allowing the organic material to serve as a cushioning material and weakening the force of the molybdenum disulfide being collided with the surface of the sliding section can be reduced. Furthermore, the energy generated at the time of the projection and collision is suppressed from being used for the organic material and for the chemical reaction of the organic material and the projecting material, whereby the energy for sliding face modification is suppressed from being reduced. Moreover, the organic material physically adsorbed to the molybdenum disulfide projecting material is suppressed from being desorbed at the time of the projection, whereby the energy can be suppressed from being consumed owing to the desorption of the organic material, and the energy for surface modification can be suppressed from being reduced.

The sliding face modification material according to a second aspect of the present invention is characterized in that the average particle diameter of the molybdenum disulfide according to the above-mentioned first aspect is set in the range of 1 μm or more to 50 μm or less. When the sliding face modification material according to the present invention configured as described above is projected by applying wind pressure or the like, the molybdenum disulfide is prevented from interfering with the organic material, whereby the projection orbit of the molybdenum disulfide is prevented from being varied.

A method for producing a sliding face modification material according to a third aspect of the present invention is characterized in that a material containing molybdenum disulfide is heated at 450° C. or less to burn and remove organic material contained in the material and to contain the organic material at 1500 ppm or less in weight ratio and the molybdenum disulfide at 95 wt % or more. In the method for producing the sliding face modification material according to the present invention configured as described above, the molybdenum disulfide is heated at 450° C. or less to burn and remove the organic material, and the molybdenum disulfide is prevented from being oxidized. As a result, the organic material interrupting stable film formation can be removed without losing the solid lubrication function inherent in the molybdenum disulfide.

A method for using a sliding face modification material according to a fourth aspect of the present invention is characterized in that the sliding face modification material containing molybdenum disulfide at 95 wt % or more and containing organic material at 1500 ppm or less in weight ratio is projected in a state of being heated at 100° C. or more onto a sliding face to form a coating layer of molybdenum disulfide. In the method for using the sliding face modification material according to the present invention configured as described above, the molybdenum disulfide particles are suppressed from adhering to each other owing to the moisture contained in the projection cycle, whereby the energy loss owing to the adhesion at the time of the projection can be prevented from increasing. Furthermore, in the method for using the sliding face modification material according to the present invention, since the sliding face modification material is heated in advance, a stable film can be formed by applying a small amount of projection energy.

A sliding member according to a fifth aspect of the present invention is characterized in that a coating layer is formed thereon by projecting a sliding face modification material containing molybdenum disulfide at 95 wt % or more and containing organic material at 1500 ppm or less in weight ratio onto the sliding face thereof and by solid-dissolving the molybdenum disulfide. In the sliding member according to the present invention configured as described above, since the film of molybdenum disulfide is formed on the surface of the sliding section thereof, the molybdenum disulfide is cleaved at a low friction coefficient and performs solid lubrication action.

A compressor for use in a system for circulating a refrigerant according to a sixth aspect of the present invention is characterized in that the sliding member according to the fifth aspect is used for at least one of members having sliding faces. In the compressor according to the present invention configured as described above, since a film of molybdenum disulfide is formed on the surface of the sliding section of the sliding member, the molybdenum disulfide is cleaved at a low friction coefficient and performs solid lubrication action, whereby the friction coefficient of the sliding section becomes low and the sliding loss is reduced.

A compressor according to a seventh aspect of the present invention accommodates an electric driving unit and a compression unit inside a hermetically sealed container storing oil, and compresses a refrigerant,

the compression unit being a reciprocating compression mechanism comprising:

a crankshaft having a main shaft to which the rotor of the electric driving unit is secured and an eccentric shaft,

a bearing section, having a thrust face for rotatably supporting the rotor, for rotatably journaling the main shaft of the crankshaft,

a cylinder block having a cylinder bore,

a piston reciprocating inside the cylinder bore,

a piston pin disposed in parallel with the eccentric shaft and secured to the piston, and

a connecting rod connecting the eccentric shaft to the piston via the piston pin, wherein

the sliding member according to the fifth aspect is used for at least one of members having sliding faces, that is, the crankshaft, the bearing section, the cylinder block, the piston, the piston pin and the connecting rod. In the reciprocating compressor according to the present invention configured as described above, the friction coefficient of the sliding section becomes low, and the sliding loss is reduced. The compressor thus has a reciprocating compression unit having high reliability and high efficiency.

A compressor according to an eighth aspect of the present invention accommodates an electric driving unit and a compression unit inside a hermetically sealed container storing oil, and compresses a refrigerant,

the compression unit being a rolling piston compression mechanism comprising:

a shaft having a main shaft to which the rotor of the electric driving unit is secured, an eccentric section being eccentric from the rotation axis of the main shaft, and an auxiliary shaft protruding from the eccentric section and being parallel with the main shaft,

a cylinder defining a compression chamber having a cylindrical space being coaxial with the rotation axis of the shaft,

a rolling piston loosely fitted in the eccentric section and rolling inside the compression chamber,

a vane making contact with the rolling piston and dividing the compression chamber into a high-pressure side and a low-pressure side,

a main bearing for sealing one of side faces of the cylinder, that is, the side face on the side of the electric driving unit, and for journaling the main shaft of the shaft,

an auxiliary bearing for sealing the other side face of the cylinder and for journaling the auxiliary shaft of the shaft,

an oil supply spring secured to the auxiliary shaft, and

an oil supply tube accommodating the oil supply spring, the open end of which is disposed in the oil, wherein

the sliding member according to the fifth aspect is used for at least one of members having sliding faces, that is, the shaft, the cylinder, the rolling piston, the vane, the main bearing, the auxiliary bearing, the oil supply spring and the oil supply tube. In the rolling piston compressor according to the present invention configured as described above, the friction coefficient of the sliding section becomes low, and the sliding loss is reduced. The compressor thus has a rotating compression unit having high reliability and high efficiency.

A sliding face modification material according to a ninth aspect of the present invention is characterized in that the sliding face modification material contains molybdenum disulfide at 95 wt % or more, that water content contained in the molybdenum disulfide is 5000 ppm or less in weight ratio, and that the sliding face modification material is projected onto a sliding face to form a coating layer of the molybdenum disulfide. The sliding face modification material according to the present invention configured as described above prevents the molybdenum disulfide powder from being aggregated, and almost all the energy of the projected sliding face modification material can be used for the chemical reaction for modifying the surface of the base material of a sliding member. Hence, the adhesion strength between the coating layer and the base material of the sliding member is raised. It is possible to provide a high-performance sliding face modification material that is hardly peeled from the base material of the sliding member.

A sliding face modification material according to a 10th aspect of the present invention is solid lubrication powder in which the average particle diameter of the molybdenum disulfide according to the ninth aspect is in the range of 1 μm or more to 50 μm or less. In the sliding face modification material according to the present invention configured as described above, since the particles of the molybdenum disulfide can be uniformly dispersed and projected, a coating layer of the molybdenum disulfide having high filling density and uniformity can be formed. It is thus possible to provide a high-performance sliding face modification material.

A method for using a sliding face modification material according to an 11th aspect of the present invention is characterized in that the sliding face modification material containing molybdenum disulfide at 95 wt % or more, water content contained in the molybdenum disulfide being 5000 ppm or less in weight ratio, is projected onto a sliding face to form a coating layer of the molybdenum disulfide, wherein the pressure of projecting the sliding face modification material is in the range of 0.5 MPa or more to 3.0 MPa or less, and the amount of the projection is in the range of 100 g/min or more to 300 g/min or less. In the method for using the sliding face modification material according to the present invention being set as described above, the projecting material, minute powder, is not aggregated and its speed can be accelerated sufficiently at any average particle diameter thereof, whereby collision energy for uniformly forming a coating layer and a chemical reaction layer on the surface of the base material of a sliding member can be supplied. As a result, it is possible to provide a high-performance sliding face modification material capable of forming a chemical reaction layer and a coating layer having uniform adhesiveness therebetween and capable of forming a uniform coating layer.

A sliding member according to a 12th aspect of the present invention is characterized in that the sliding face modification material according to the ninth aspect or the 10th aspect is projected onto the sliding face of a sliding member made of a metallic material to form a coating layer in which molybdenum disulfide is solid-dissolved. In the sliding member according to the present invention configured as described above, since the coating layer has a layer lattice structure, the coating layer is apt to slide easily with low shearing force, and the friction coefficient can be lowered. It is thus possible to provide a sliding member having low friction coefficient, high reliability and high efficiency.

A compressor according to a 13th aspect of the present invention being used for a system for circulating a refrigerant is characterized in that the sliding member according to the 12th aspect is used for at least one of members having sliding faces. In the compressor according to the present invention configured as described above, the adhesion strength between the coating layer and the base material of the sliding member is high, and the coating layer is prevented from being peeled from the base material of the sliding member. It is thus possible to provide a compressor having high reliability and high energy efficiency.

A compressor according to a 14th aspect of the present invention accommodates an electric driving unit and a compression unit inside a hermetically sealed container storing oil, and compresses a refrigerant,

the compression unit being a reciprocating compression mechanism comprising:

a crankshaft having a main shaft to which the rotor of the electric driving unit is secured and an eccentric shaft,

a bearing section, having a thrust face for rotatably supporting the rotor, for rotatably journaling the main shaft of the crankshaft,

a cylinder block having a cylinder bore,

a piston reciprocating inside the cylinder bore,

a piston pin disposed in parallel with the eccentric shaft and secured to the piston, and

a connecting rod connecting the eccentric shaft to the piston via the piston pin, wherein

the sliding member according to the 12th aspect is used for at least one of members having sliding faces, that is, the crankshaft, the bearing section, the cylinder block, the piston, the piston pin and the connecting rod. In the reciprocating compressor according to the present invention configured as described above, since the coating layer is formed on the sliding face of at least one of the sliding members, that is, the crankshaft, the bearing section, the cylinder block, the piston, the piston pin and the connecting rod, the adhesion strength between the coating layer and the base material of the sliding member is high, and the coating layer is hardly peeled from the base material of the sliding member in this structure. Furthermore, since the coating layer has a layer lattice structure, the coating layer is apt to slide easily with low shearing force, the friction coefficient of the sliding member becomes low, and the sliding loss is reduced. It is thus possible to provide a reciprocating compressor having high reliability and high efficiency.

A compressor according to a 15th aspect of the present invention accommodates an electric driving unit and a compression unit inside a hermetically sealed container storing oil, and compresses a refrigerant,

the compression unit being a rolling piston compression mechanism comprising:

a shaft having a main shaft to which the rotor of the electric driving unit is secured, an eccentric section being eccentric from the rotation axis of the main shaft, and an auxiliary shaft protruding from the eccentric section and being parallel with the main shaft,

a cylinder having a compression chamber having a cylindrical space being coaxial with the rotation axis of the shaft,

a rolling piston loosely fitted in the eccentric section and rolling inside the compression chamber,

a vane making contact with the rolling piston and dividing the compression chamber into a high-pressure side and a low-pressure side,

a main bearing for sealing one of side faces of the cylinder, that is, the side face on the side of the electric driving unit, and for journaling the main shaft of the shaft,

an auxiliary bearing for sealing the other side face of the cylinder and for journaling the auxiliary shaft of the shaft,

an oil supply spring secured to the auxiliary shaft, and

an oil supply tube accommodating the oil supply spring, the open end of which is disposed in the oil, wherein

the sliding member according to the 12th aspect is used for at least one of the members having sliding faces, that is, the shaft, the cylinder, the rolling piston, the vane, the main bearing, the auxiliary bearing, the oil supply spring and the oil supply tube. In the rolling piston compressor according to the present invention configured as described above, since the coating layer is formed on the sliding face of at least one of the sliding members, that is, the shaft, the cylinder, the rolling piston, the vane, the main bearing, the auxiliary bearing, the oil supply spring and the oil supply tube, the adhesion strength between the coating layer and the base material of the sliding member is high, and the coating layer is hardly peeled from the base material of the sliding member in this structure. Furthermore, since the coating layer has a layer lattice structure, the coating layer is apt to slide easily with low shearing force, the friction coefficient of the sliding member becomes low, and the sliding loss is reduced. It is thus possible to provide a rolling piston compressor having high reliability and high efficiency.

A stable film of molybdenum disulfide can be formed securely on the surface of a sliding member using the sliding face modification material according to the present invention, and it is thus possible to provide a sliding member and a compressor having high reliability. In addition, a stable film of molybdenum disulfide can be formed securely and easily using the method for producing the sliding face modification material according to the present invention. Furthermore, a sliding face can be modified securely using the method for using the sliding face modification material according to the present invention, and a highly reliable sliding member can be formed. Since the sliding sections of the sliding members of the compressor according to the present invention are high in reliability, the compressor has excellent refrigerant compression efficiency.

In the present invention, the water content in the sliding face modification material is made lower than a predetermined value, and a coating layer having high adhesion strength between molybdenum disulfide and the base material of a sliding member is formed, whereby peeling of the coating layer from the base material of the sliding member can be reduced. Furthermore, the friction coefficient of the sliding member can be lowered and the sliding loss thereof can be reduced by virtue of the solid lubrication function of the coating layer formed as described above. It is thus possible to provide a sliding member having high reliability and to provide a compressor having high reliability and high efficiency using the sliding member.

### BRIEF DESCRIPTION OF DRAWINGS

FIG. 1 is a vertical sectional view showing the configuration of a reciprocating compressor according to Embodiment 1 of the present invention;

FIG. 2 is an enlarged view showing portion A in FIG. 1;

FIG. 3 is an enlarged perspective view showing portion B in FIG. 2;

FIG. 4 is a view illustrating a method for forming a coating layer of molybdenum disulfide according to Embodiment 1 of the present invention;

FIG. 5 is a vertical sectional view showing the configuration of a rolling piston compressor according to Embodiment 2 of the present invention;

FIG. 6 is a sectional view taken on line VI-VI of FIG. 5;

FIG. 7 is an enlarged perspective view showing portion E in FIG. 6;

FIG. 8 is an enlarged view showing the vicinity of a compression unit according to Embodiment 3 of the present invention;

FIG. 9 is an enlarged perspective view showing portion C serving as a sliding section;

FIG. 10 is a view illustrating a method for forming a coating layer of molybdenum disulfide according to Embodiment 3 of the present invention;

FIG. 11 is a graph showing the relationship between the water content contained in a molybdenum disulfide projecting material and the film thickness of a chemical reaction layer according to Embodiment 3 of the present invention;

FIG. 12 is a view showing the characteristics of the compressor according to Embodiment 3 and the conventional compressor;

FIG. 13 is an enlarged perspective view showing a sliding section according to Embodiment 4 of the present invention;

FIG. 14 is a view illustrating a method for forming a coating layer of molybdenum disulfide according to Embodiment 4 of the present invention;

FIG. 15 is a graph showing the relationship between the water content contained in a molybdenum disulfide projecting material and the film thickness of a chemical reaction layer according to Embodiment 4 of the present invention;

FIG. 16 is a vertical sectional view showing the configuration of the conventional compressor; and

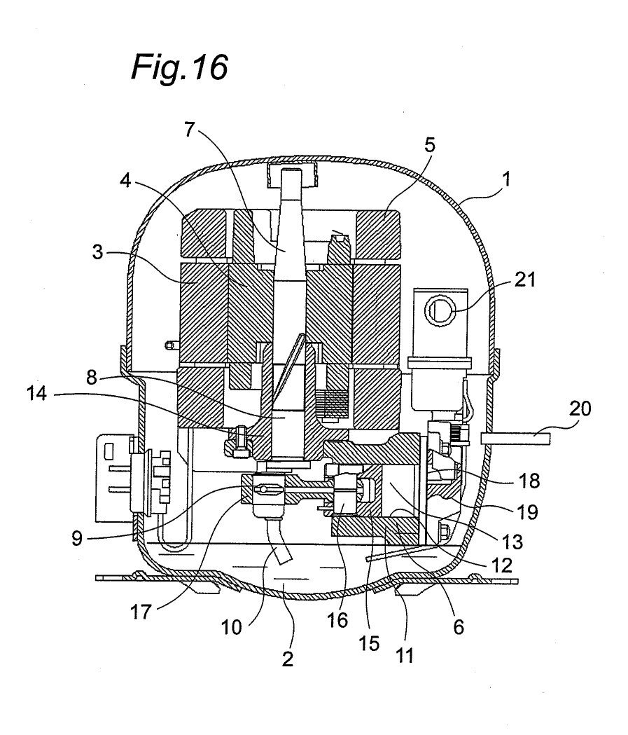

FIG. 17 is an enlarged perspective view showing the sliding face of the conventional sliding member.

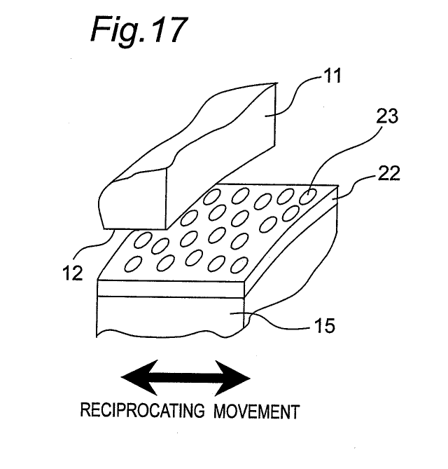

### BEST MODE FOR CARRYING OUT THE INVENTION

A sliding face modification material, a method for producing the sliding face modification material, a method for using the sliding face modification material, and sliding members modified using the sliding face modification material according to the present invention will be described below by taking a compressor comprising sliding members as a preferred embodiment referring to the accompanying drawings. Although the present invention will be described in some detail with respect to its preferred embodiments described below, the disclosed contents of the preferred embodiments may change in the details of the configuration thereof, and any changes in the combination and sequence of the components may be attained without departing from the technical concept of the present invention.

### Embodiment 1

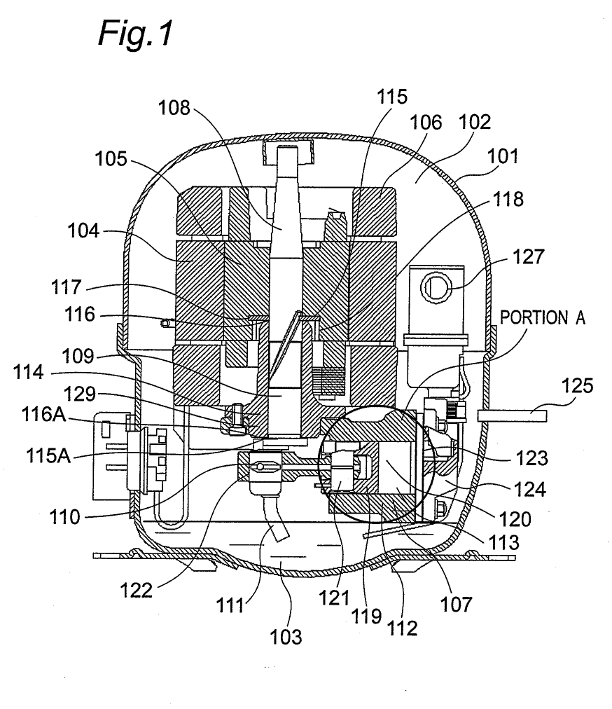

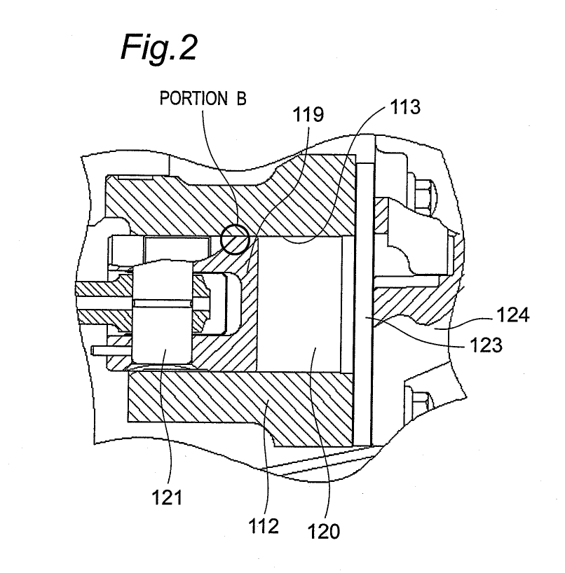

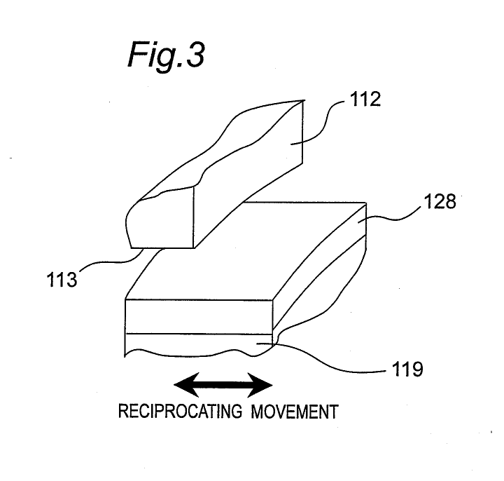

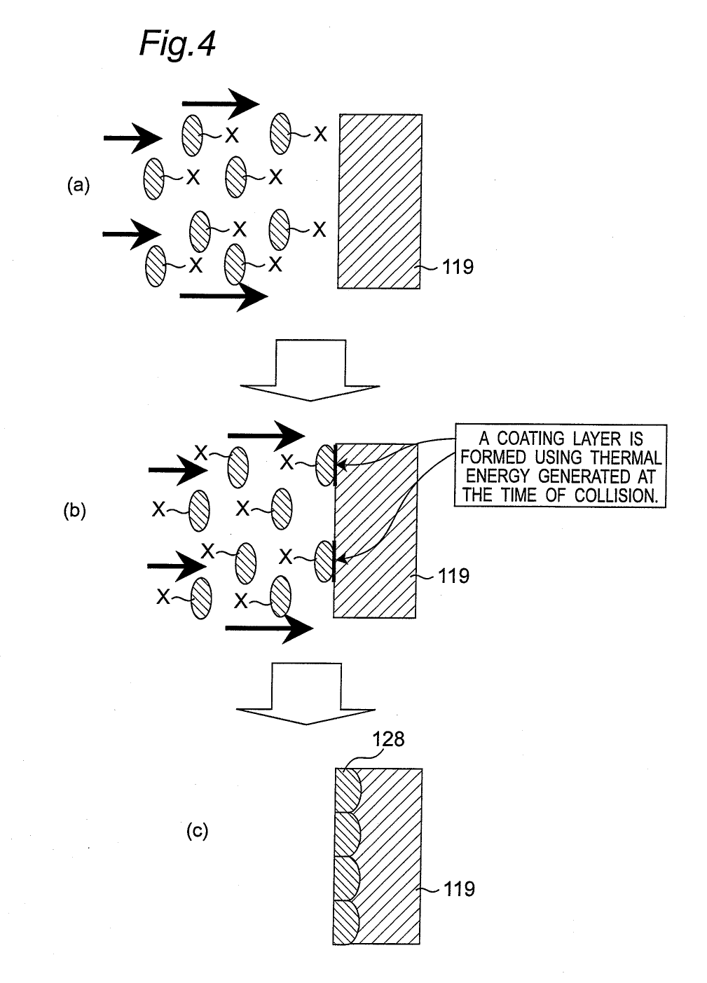

FIG. 1 is a vertical sectional view showing the internal configuration of a reciprocating compressor according to Embodiment 1 of the present invention. FIG. 2 is an enlarged sectional view showing a portion indicated by letter A in FIG. 1. FIG. 3 is an enlarged perspective sectional view schematically showing a portion indicated by letter B in FIG. 2. FIG. 4 is a view schematically showing a method for forming a coating layer on a sliding section in the compressor according to Embodiment 1.

In FIG. 1, a refrigerant 102 consisting of R600a or R134a is filled in a hermetically sealed container 101, and oil 103 is stored in the bottom section thereof. In addition, an electric driving unit 106 comprising a stator 104 and a rotor 105, and a reciprocating compression unit 107 driven using this electric driving unit 106 are accommodated in the hermetically sealed container 101. In the compression unit 107, the refrigerant 102 introduced into the hermetically sealed container 101 through a suction tube 125 is suctioned via a suction muffler 127 and compressed. The compressed refrigerant 102 is fed to a refrigeration cycle serving as a refrigerant circulation system through a discharge tube (not shown).

Next, the compression unit 107 of the reciprocating compressor according to Embodiment 1 configured as described below will be described below.

In the compressor according to Embodiment 1, a crankshaft 108 serving as the drive shaft of the compression unit 107 comprises a main shaft 109 on which the rotor 105 is pressure-fitted so as to be secured thereto and an eccentric shaft 110 formed so as to eccentric with respect to this main shaft 109. The lower end of the eccentric shaft 110 is provided with an oil pump 111 to supply the oil 103, the oil supply port of the oil pump being dipped in the oil. The eccentric shaft 110 is connected to the piston 119 of the compression unit 107 via a connecting rod 122 serving as a connecting means. A cylinder bore 113 in which the piston 119 reciprocates is formed inside a cylinder block 112 made of cast iron. The cylinder block 112 has a compression chamber 120, the inner circumferential face of which is defined by the cylinder bore 113 having a nearly cylindrical shape. Furthermore, the cylinder block 112 is provided with a bearing section 114 for journaling the main shaft 109.

In the rotor 105 for rotating the main shaft 109, a flange face 115 is formed at a position opposed to the bearing section 114 (the position of the downward face in FIG. 1), and the upper end face of the bearing section 114 opposed to the flange face 115 serves as a thrust face 116. A thrust washer 117 is inserted between the flange face 115 of the rotor 105 and the thrust face 116 of the bearing section 114. The flange face 115, the thrust face 116 and the thrust washer 117 constitute a thrust bearing section 118.

The piston 119 loosely fitted in the cylinder bore 113 with a minute clearance provided to reduce leakage loss is made of cast iron or an iron-based material, such as an iron-based sintered material, and forms the compression chamber 120 together with the cylinder bore 113. The piston 119 is connected to the eccentric shaft 110 using the connecting rod 122 serving as a connecting means via a piston pin 121. According to Embodiment 1, the piston 119 is loosely fitted in the cylinder bore 113 with a clearance of, for example, approximately 5 to 15 μm in terms of the difference in diameter. In addition, the end face of the cylinder bore 113, opposed to the ceiling face of the piston 119, is sealed using a valve plate 123 secured to the cylinder block 112.

The face of the valve plate 123 on the opposite side of the cylinder block 112 is provided with a cylinder head 124. In this cylinder head 124, a high-pressure chamber (not shown) and a low-pressure chamber (not shown), capable of being communicated with the cylinder bore 113, are formed.

The hermetically sealed container 101 is provided with the suction tube 125 for supplying the refrigerant 102 into the hermetically sealed container 101 and the discharge tube (not shown) for discharging the compressed refrigerant 102 from the hermetically sealed container 101. The suction tube 125 and the discharge tube (not shown) are secured to the hermetically sealed container 101 and connected to the refrigeration cycle (not shown). Hence, the suction tube 125 is used to introduce the refrigerant 102 into the hermetically sealed container 101, and the discharge tube (not shown) is used to feed the refrigerant 102 to the refrigeration cycle (not shown). The suction muffler 127 serving as a silencer and connected so that the refrigerant introduced into the hermetically sealed container 101 is further introduced into the compression chamber 120 is held between the valve plate 123 and the cylinder head 124.

In the compressor according to Embodiment 1 wherein the compression unit 107 is configured and operates as described above, mutually sliding sections are formed between the sliding members of the compressor, that is, between the piston 119 and the cylinder block 112, between the main shaft 109 and the bearing section 114, between the thrust face 116 of the bearing section 114 and the thrust washer 117, between the piston pin 121 and the connecting rod 122, and between the eccentric shaft 110 and the connecting rod 122. A coating layer 128 is formed on the surface of at least one of the sliding sections. This coating layer 128 is formed by projecting a molybdenum disulfide projecting material having an average particle diameter of 8 μm and a molybdenum disulfide content of 95 wt % or more. In the molybdenum disulfide projecting material being used to form the coating layer 128 in the compressor according to Embodiment 1, the organic material content contained in the molybdenum disulfide projecting material immediately before the projection is 1500 ppm or less in weight ratio.

The coating layer 128 of the sliding section in the compressor according to Embodiment 1 will be described below in detail by taking an example in which the coating layer 128 is formed on the sliding face of the piston 119.

FIG. 3 is a partially enlarged view showing the mutually sliding sections of the piston 119 disposed inside the cylinder bore 113 and the cylinder block 112. As shown in FIG. 3, the molybdenum disulfide projecting material having a special configuration is projected onto the sliding face of the piston 119 among the sliding sections of the piston 119 and the cylinder block 112, and the coating layer 128 is formed. Referring to FIG. 3, the piston 119 reciprocates in the horizontal direction along the sliding face, that is, the inner circumferential face of the cylinder bore 113 formed in the cylinder block 112.

Next, a method for forming the coating layer 128 on the sliding face of the sliding section will be described below.

FIG. 4 is a schematic view illustrating a method for forming the coating layer 128 on the surface of the sliding section using the molybdenum disulfide projecting material.

The projecting material that is used for the method for forming the coating layer on the sliding section (for example, the sliding section of the piston 119) in the compressor according to Embodiment 1 of the present invention has a molybdenum disulfide content of 95 wt % or more and an average particle diameter of 8 μm.

In the coating layer forming method, first, a molybdenum disulfide material, a natural product, is heated at 450° C. so that the organic material content thereof is reduced to 1500 ppm or less in weight ratio, whereby a molybdenum disulfide projecting material X having an average particle diameter of 8 μm and a molybdenum disulfide content of 95 wt % or more is produced. The molybdenum disulfide projecting material produced as described above and maintained at a temperature of 100° C. or more is projected onto the sliding face of the sliding section of a sliding member made of metal (for example, the surface of the piston 119) at a speed of 100 m/s or more, together with a carrier gas, such as dry air, whereby the molybdenum disulfide projecting material X is collided with the sliding face (refer to FIG. 4(a)). The projection speed of the molybdenum disulfide projecting material X is preferably required to be at least 100 m/s or more, although the preferable speed differs depending on the material of the sliding face onto which the projecting material is projected. If the projection speed is lower than 100 m/s, the thermal energy at the time when the molybdenum disulfide projecting material X is collided with the sliding face becomes insufficient, and the coating layer 128 may not be formed properly in some cases.

When the molybdenum disulfide projecting material X is projected onto the surface of the sliding section as described above, the kinetic energy of the molybdenum disulfide projecting material X collided with the surface of the sliding section is converted into thermal energy (refer to FIG. 4(b)). As a result, a surface modifying treatment performed by the collision of the molybdenum disulfide projecting material X is carried out on the sliding face, and the coating layer 128 is formed (refer to FIG. 4(c)).

The operation of the reciprocating compressor according to Embodiment 1 wherein the coating layer 128 is formed on the sliding section of the sliding member as described above will be described below.

The electric power from a power supply (not shown) is supplied to the electric driving unit 106, and the rotor 105 of the electric driving unit 106 is rotated. The rotor 105 rotates the crankshaft 108, and the eccentric shaft 110 of the crankshaft 108 performs eccentric movement. Owing to the eccentric movement of the eccentric shaft 110, the piston 119 of the compression unit 107 reciprocates inside the cylinder bore 113 via the connecting rod 122 and the piston pin 121. The refrigerant 102 introduced into the hermetically sealed container 101 through the suction tube 125 is suctioned from the suction muffler 127 by the reciprocating movement of the piston 119 inside the cylinder bore 113 and compressed inside the compression chamber 120.

As the crankshaft 108 is rotated, the oil 103 stored inside the hermetically sealed container 101 is supplied from the oil pump 111 to respective sliding sections so as to lubricate the sliding sections and is also supplied to the clearance between the piston 119 and the cylinder bore 113 so as to function as a seal.

The refrigerant 102 compressed inside the compression chamber 120 of the compression unit 107 is fed to the refrigeration cycle (not shown) through the discharge tube (not shown), circulated inside the refrigeration cycle and introduced again into the hermetically sealed container 101 through the suction tube 125.

In the conventional compressor, when the piston reciprocates inside the cylinder bore, since the clearance between the piston and the cylinder bore is very small, mutually contacting portions are present partially owing to variations in shape and accuracy of the piston and the cylinder bore. However, in the compressor according to Embodiment 1 of the present invention, since the coating layer 128 formed by projecting the molybdenum disulfide projecting material is formed on at least one of the sliding faces of the sliding sections, partial mutual contact does not occur at the sliding sections, and smooth sliding movement is attained.

The molybdenum disulfide has a property of cleaving in the sliding direction, and the size of its molecule is small, approximately 6×10⁻⁴ μm. Hence, the molybdenum disulfide is cleaved at a low friction coefficient, and the friction coefficient of the sliding section becomes low, and the sliding loss is reduced. For this reason, it is possible to provide a compressor having high efficiency and high reliability by forming the coating layer 128 having the molybdenum disulfide on the sliding sections.

Next, the effect of the organic material content contained in the molybdenum disulfide projecting material on the formation of the coating layer and the abrasion of the sliding section of a sliding member, such as the piston 119, will be described below.

TABLE 1 shown below summarizes the results of a reliability test conducted under the conditions that the organic material content contained in the molybdenum disulfide projecting material is changed from 900 to 1600 ppm, that the molybdenum disulfide projecting material is projected onto the surface of the sliding section of the piston 119 to form the coating layer 128, that the piston 119 having the coating layer 128 is installed in the compressor, that R600a or R134a is used as the refrigerant 102, and that mineral oil or ester oil is used as the oil 103.

TABLE 1

| | Abrasion caused or not | Abrasion caused or not | Concentration |
|---|---|---|---|
| Organic | when reliability | when reliability | of molybdenum |
| matter | test was conducted | test was conducted | disulfide on |
| content | using R600a and mineral oil | using R134a and ester oil | piston surface |
| 900 ppm | No abrasion | No abrasion | 10-15% |
| 1250 ppm | No abrasion | No abrasion | 10-15% |
| 1500 ppm | No abrasion | No abrasion | 10-15% |
| 1600 ppm | Abrasion was not observed | Abrasion was not observed | 5-7% |
| | visually, but peeling was | visually, but peeling was | |
| | observed on part of the | observed on part of the | |
| | surface of the piston. | surface of the piston. | |

The results of the reliability test shown in TABLE 1 were obtained when the compressor was operated for 500 hours under operation conditions, such as at a condensation temperature of 51° C. and an evaporating temperature of −25° C., and when the abrasion state of the piston 119 was examined. In addition, before the piston 119 was installed in the compressor, the concentration of the molybdenum disulfide contained in the coating layer 128 of the piston 119 was measured using EDX (energy dispersion fluorescence X-ray spectrometer).

As shown in TABLE 1, the concentration of the molybdenum disulfide when the organic material content is 1600 ppm is lower than that when the organic material content is 1500 ppm or less. It seems that this is caused by the fact that since the average particle diameter of the molybdenum disulfide used in Embodiment 1 is small, 8 μm, when the molybdenum disulfide was projected, the molybdenum disulfide interfered with the organic material, the projection orbit was varied, and the concentration of the molybdenum disulfide on the surface of the sliding section of the piston 119 was reduced. The average particle diameter mentioned herein is a value measured using a measuring instrument based on the electrical sensing zone method that is used generally.

Furthermore, according to the results of the reliability test, when the coating layer 128 was formed on the sliding face of the piston 119 by projecting the molybdenum disulfide projecting material having an organic material content of 1600 ppm, part of the coating layer 128 was peeled. However, when the coating layer 128 was formed using the molybdenum disulfide projecting material having an organic material content of 1600 ppm, abrasion was not observed visually.

It seems that this peeling was caused by the following reasons. Since the molybdenum disulfide projecting material contains organic material, when the projecting material was projected, the organic material was first attached to the surface of the sliding section and served as a cushioning material, and the force of the molybdenum disulfide being collided with the surface of the sliding section was weakened. In addition, the energy generated at the time of the projection and collision was used for the organic material and for the chemical reaction of the organic material and the projecting material, and the energy for surface modification was reduced. Furthermore, the organic material physically adsorbed to the molybdenum disulfide projecting material by, for example, attachment thereto, was desorbed at the time of the projection, and the energy was consumed owing to the desorption, and the energy for surface modification was reduced. Eventually, the adhesiveness to the surface of the sliding section was weakened, and the peeling was caused.

Hence, according to the coating layer forming method according to Embodiment 1, since the organic material content contained in the molybdenum disulfide projecting material is reduced to 1500 ppm or less in weight ratio, when the projecting material is projected onto the surface of the sliding section by applying wind pressure or the like, the probability that the organic material is attached to the surface of the sliding section of the sliding member earlier than the molybdenum disulfide is significantly reduced. Hence, it seems that the adverse effect of allowing the organic material to serve as a cushioning material and weakening the force of the molybdenum disulfide being collided with the surface of the sliding section is reduced.

In addition, it seems that the coating layer forming method according to Embodiment 1 can suppress the energy generated at the time of the projection and collision from being used for the organic material and for the chemical reaction of the organic material and the projecting material, thereby suppressing the energy for surface modification from being reduced. Furthermore, it seems that the coating layer forming method suppresses the organic material physically adsorbed to the molybdenum disulfide projecting material by, for example, attachment thereto, from being desorbed at the time of the projection, thereby suppressing the energy from being consumed owing to the desorption of the organic material and suppressing the energy for surface modification from being reduced.

In the coating layer forming method according to Embodiment 1, the molybdenum disulfide material serving as a projecting material is heated at 450° C. or less for a short time so that the organic material contained in the molybdenum disulfide projecting material is burnt. As a result, almost all the organic material was removed without oxidizing the molybdenum disulfide and without changing the lubricating function of the molybdenum disulfide. The organic material interrupting stable film formation can be removed by heating the molybdenum disulfide projecting material at a desired temperature as described above without losing the solid lubrication function inherent in the molybdenum disulfide.

Hence, in the coating layer forming method according to Embodiment 1, since the molybdenum disulfide projecting material is heated at the desired temperature so that the organic material content is reduced to 1500 ppm or less, the coating layer 128 is formed securely by projecting the molybdenum disulfide projecting material onto the surface of the sliding section of a sliding member made of metal, such as the piston 119. As a result, the surface of the sliding section is prevented from being abraded, and a sliding member having high reliability can be provided.

In addition, in the coating layer forming method according to Embodiment 1, at the time of the projection of the molybdenum disulfide projecting material, the molybdenum disulfide projecting material is projected onto the surface of the sliding section while its temperature is maintained at a temperature of 100° C. or more. Hence, the molybdenum disulfide particles are suppressed from adhering to each other owing to the dew condensation occurred in the projection cycle and the moisture slightly contained in the carrier gas. As a result, the energy loss owing to the adhesion at the time of the projection is suppressed significantly.

Furthermore, by maintaining the molybdenum disulfide projecting material at a temperature of 100° C. or more, any oil mist mixed in the carrier gas or air can be suppressed from being mixed into the molybdenum disulfide projecting material, whereby a stable film can be formed. Moreover, in the coating layer forming method, since the molybdenum disulfide projecting material is heated in advance, a stable film can be formed by applying a small amount of projection energy. Besides, by raising the temperature of the molybdenum disulfide projecting material to 450° C., even if any oil mist is mixed in the carrier gas or air, the possibility of the mixture of the oil mist into the molybdenum disulfide projecting material can be reduced further.

In addition, even if the molybdenum disulfide is heated at 450° C., if the heating time is short (for example, one minute or less), the adverse effect of changing the lubrication function of the molybdenum disulfide owing to oxidation reaction can be suppressed. For this reason, even when the molybdenum disulfide projecting material to which oil having a high boiling point (for example, 400° C.), such as rust-inhibiting oil, is attached, is heated, the organic material content can be adjusted to 1500 ppm or less.

Furthermore, in the coating layer forming method according to Embodiment 1, although the molybdenum disulfide projecting material having an average particle diameter of 8 μm is used, a similar effect is obtained, provided that the average particle diameter is in the range of 1 μm or more to 50 μm or less. According to experiments conducted by the inventors, it has been verified that if the average particle diameter is less than 1 μm, even if the molybdenum disulfide projecting material is projected onto the surface of a sliding member, no film is formed in many cases. It seems that if the average particle diameter is less than 1 μm, the energy generated when the molybdenum disulfide projecting material is collided with the surface of the sliding member becomes too small. Still further, if the average particle diameter is more than 50 μm, when the coating layer 128 was formed by projecting the molybdenum disulfide projecting material onto on the surface of the sliding member and when the sliding member was installed in the compressor, the effect of the coating layer was not produced in some cases. It seems that this is because the surface roughness of the surface of the sliding member increases, and it becomes difficult to obtain the effect of reducing the friction coefficient.

In addition, in Embodiment 1, although a compressor operating at a constant speed has been described, as the inverter technology is applied to compressors in recent years, compressor operation speed becomes lower. In particular, during a very low speed operation at less than 20 Hz, it is further difficult to maintain fluid lubrication, and there is a growing problem that metal-to-metal contact occurs between the sliding sections of sliding members and that abnormal abrasion is caused. This problem of abnormal abrasion during the very low speed operation is solved by forming the coating layer described in Embodiment 1 on the surfaces of the sliding sections, and the effect of the coating layer is produced significantly.

Furthermore, in Embodiment 1, although an example in which the coating layer 128 is formed by projecting the molybdenum disulfide projecting material onto the surface of the sliding section of the piston 119, that is, one of the sliding faces of the sliding sections, has been described, the coating layer 128 may also be formed on the surface of the sliding section of the cylinder bore 113, that is, the other sliding face, or the coating layer 128 may also be formed on both the sliding faces of the piston 119 and the cylinder bore 113. Higher abrasion resistance is obtained by forming the coating layer 128 on both the sliding faces of the mutually sliding sections of the sliding members as described above.

Moreover, in Embodiment 1, although an example in which the coating layer 128 is formed on the surface of the sliding section of the piston 119 has been described in detail, even when the coating layer 128 is formed on other mutually sliding sections of the sliding members of the compressor, for example, the main shaft 109 of the crankshaft 108 and the bearing section 114; the flange face 115 of the rotor 105 and the thrust washer 117; the thrust face 116, that is, the upper end face of the bearing section 114, and the thrust washer 117; the piston pin 121 and the connecting rod 122; and the eccentric shaft 110 and the connecting rod 122, an effect similar to the effect described in Embodiment 1 is produced.

Besides, in Embodiment 1, although an example in which the thrust bearing section 118 serving as a sliding member between the rotor 105 and the bearing section 114 comprises the flange face 115, the thrust face 116, and the thrust washer 117 disposed therebetween has been described, the thrust bearing section may be provided at another position. For example, the thrust bearing section may be configured by forming the flange face 115A of the crankshaft 108 at the position opposed to the bearing section 114 in the flange section 129 formed between the main shaft 109 of the crankshaft 108 and the eccentric shaft 110 and by forming a thrust face 116A at the position of the bearing section 114 sliding against the flange face 115A. In this case, an effect similar to the effect described in Embodiment 1 is produced by forming the coating layer 128 on at least one of the sliding sections.

Still further, in the compressor according to Embodiment 1 of the present invention, a similar effect is obtained when R600a or R290 or a mixed solvent of these or a refrigerant selected from the group consisting of R134a, R152, R407C, R404A and R410 is used as the refrigerant 102.

As described above in Embodiment 1 of the present invention, a highly reliable sliding member can be provided by forming the coating layer on the surface of the sliding section thereof using the molybdenum disulfide projecting material serving as a sliding face modification material, and the compressor incorporating the sliding member has high reliability. As a result, it is possible to provide an apparatus capable of carrying out compression at high efficiency.

Since the organic material content contained in the molybdenum disulfide projecting material serving as a sliding face modification material according to Embodiment 1 of the present invention is reduced to 1500 ppm or less in weight ratio, when the projecting material is projected onto the surface of a sliding section by applying wind pressure or the like, the probability that the organic material is attached to the surface of the sliding section earlier than the molybdenum disulfide is reduced. Hence, the adverse effect of allowing the organic material to serve as a cushioning material and weakening the force of the molybdenum disulfide being collided with the surface of the sliding section can be reduced.

In addition, the sliding face modification material according to Embodiment 1 of the present invention can suppress the energy generated at the time of the projection and collision from being used for the organic material and for the chemical reaction of the organic material and the projecting material, thereby suppressing the energy for surface modification from being reduced. Furthermore, the sliding face modification material can suppress the organic material physically adsorbed to the molybdenum disulfide projecting material from being desorbed at the time of the projection, thereby suppressing the energy from being consumed owing to the desorption of the organic material and suppressing the energy for surface modification from being reduced.

The molybdenum disulfide projecting material serving as a sliding face modification material according to Embodiment 1 is obtained by heating a molybdenum disulfide material serving as the raw material of the projecting material at 450° C. or less so that the organic material contained therein is burnt and removed. In the sliding face modification material according to Embodiment 1 formed as described above, since the molybdenum disulfide material is heated for a short time, the molybdenum disulfide is prevented from being oxidized. Hence, the organic material interrupting coating layer formation is removed without losing the solid lubrication function inherent in the molybdenum disulfide. As a result, a stable coating layer can be formed.

In addition, since the molybdenum disulfide projecting material serving as a sliding face modification material according to Embodiment 1 has an average particle diameter in the range of 1 to 50 μm and has an organic material content of only 1500 ppm or less, when the projecting material is projected by applying wind pressure or the like, the molybdenum disulfide is prevented from interfering with the organic material, whereby the projection orbit of the molybdenum disulfide is prevented from being varied.

Furthermore, since the molybdenum disulfide projecting material serving as a sliding face modification material according to Embodiment 1 is projected onto the surface of the sliding section of a target sliding member while the projecting material is heated at 100° C. or more, mutual adhesion of the molybdenum disulfide particles owing to the moisture contained in the projection cycle is reduced. As a result, the energy loss owing to the adhesion at the time of the projection is prevented from increasing. Moreover, by projecting the molybdenum disulfide projecting material serving as a sliding face modification material while its temperature is maintained at a higher temperature, the possibility of mixing any oil mist contained in the carrier gas or air with the molybdenum disulfide projecting material can be lowered, and a stable film can be formed. Still further, since the molybdenum disulfide projecting material serving as a sliding face modification material is heated in advance in the coating layer forming process, a stable film can be formed by applying a small amount of projection energy.

In addition, since the process of forming the film of molybdenum disulfide is carried out by projecting the molybdenum disulfide projecting material onto the sliding face of the sliding section of a sliding member according to Embodiment 1, such as the piston, the molybdenum disulfide is cleaved at a low friction coefficient and performs solid lubrication action. As a result, the friction coefficient of the sliding face becomes low, and the sliding loss can be reduced.

Furthermore, in the reciprocating compressor incorporating the sliding members according to Embodiment 1, the molybdenum disulfide projecting material is projected onto the sliding face of at least one of the sliding members made of metallic materials and selected from the group consisting of the crankshaft, the bearing section, the cylinder block, the piston, the piston pin and the connecting rod, thereby forming a coating layer. Hence, the friction coefficient of the sliding member becomes low, and an excellent effect capable of remarkably reducing the sliding loss is produced. In particular, the clearance between the piston and the cylinder bore is not increased, and the compressed refrigerant does not leak from the clearance between the piston and the cylinder bore. Therefore, a compressor having a reciprocating compression unit being high in reliability and efficiency can be provided according to Embodiment 1 of the present invention.

### Embodiment 2

Next, a rolling piston compressor according to Embodiment 2 of the present invention will be described below referring to the accompanying drawings.

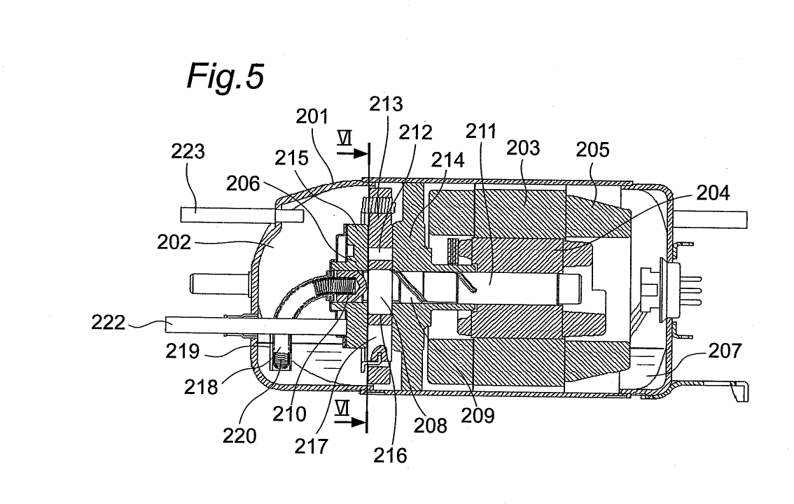

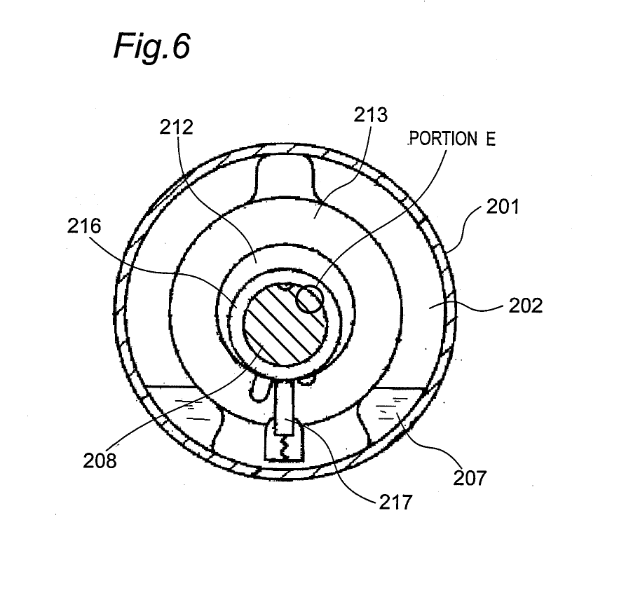

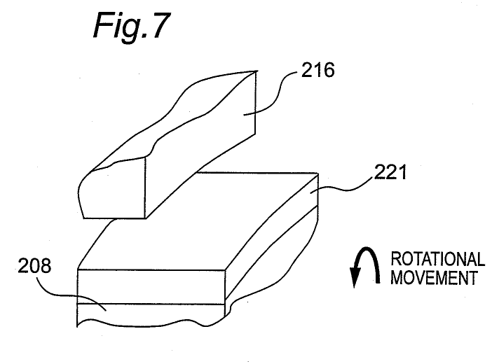

FIG. 5 is a vertical sectional view showing the rolling piston compressor according to Embodiment 2 of the present invention. FIG. 6 is a sectional view taken on line VI-VI of FIG. 5. FIG. 7 is an enlarged perspective view showing portion E in FIG. 6.

In FIGS. 5 and 6, a hermetically sealed container 201 is filled with a refrigerant 202. In addition, an electric driving unit 205 comprising a stator 203 and a rotor 204, a rolling piston compression unit 206 driven using the electric driving unit 205, and oil 207 are accommodated inside the hermetically sealed container 201.

The compression unit 206 comprises a shaft 211 driven using the electric driving unit 205; a cylinder 213 through which the shaft 211 passes; a main bearing 214 secured to one of the faces of the cylinder 213, that is, the face on the side of the electric driving unit 205; an auxiliary bearing 215 secured to the other face of the cylinder 213; a rolling piston 216 operating simultaneously with the shaft 211; and a vane 217 making pressure contact with the rolling piston 216. The shaft 211 comprises an eccentric section 208, a main shaft 209 and an auxiliary shaft 210. The rotor 204 of the electric driving unit 205 is pressure-fitted onto the main shaft 209 of the shaft 211 and secured thereto. A compression chamber 212 is formed inside the cylinder 213 in which the eccentric section 208 of the shaft 211 is disposed. Both end faces of the compression chamber 212 are sealed using the main bearing 214 for journaling the main shaft 209 and the auxiliary bearing 215 for journaling the auxiliary shaft 210. The rolling piston 216 is loosely fitted in the eccentric section 208 and configured so as to rotate inside the compression chamber 212. A pressing means is provided at one end of the vane 217 having a plate-like shape so that the other end of the vane makes contact with the surface of the rolling piston 216. The vane 217 has a function of dividing the compression chamber 212 into a high-pressure side (not shown) and a low-pressure side (not shown).

The hermetically sealed container 201 is provided with a suction tube 222 for supplying the refrigerant 202 into the hermetically sealed container 201 and a discharge tube 223 for discharging the compressed refrigerant 202 from the hermetically sealed container 201. The suction tube 222 and the discharge tube 223 are secured to the hermetically sealed container 201 and connected to a refrigeration cycle (not shown) serving as a refrigerant circulation system. Hence, the suction tube 222 is used to introduce the refrigerant 202 into the hermetically sealed container 201, and the discharge tube 223 is used to feed the refrigerant 202 to the refrigeration cycle (not shown).

As shown in FIG. 5, an oil pump 218 is secured to the auxiliary bearing 215, and the oil pump 218 comprises an oil supply tube 219 and an oil supply spring 220 disposed inside this oil supply tube 219. The open end at the tip of the oil supply tube 219 is dipped in the oil 207. The oil pump 218 supplies the oil 207 stored in the hermetically sealed container 201 to the sliding sections of the sliding members in the compressor, for example, the eccentric section 208 and the rolling piston 216, the main shaft 209 and the main bearing 214, and the auxiliary shaft 210 and the auxiliary bearing 215.

In the rolling piston compressor according to Embodiment 2, the molybdenum disulfide projecting material having an average particle diameter of 8 μm and a molybdenum disulfide content of 95 wt % or more is projected onto the surfaces of the sliding sections of the eccentric section 208, the main shaft 209 and the auxiliary shaft 210 of the shaft 211, whereby coating layer 221 is formed on each surface. When this coating layer 221 is formed, the organic material content contained in the molybdenum disulfide projecting material immediately before the projection is set at 1500 ppm or less in weight ratio.

Next, a method for forming the coating layer 221 by projecting the molybdenum disulfide projecting material according to Embodiment 2 will be described below. The projecting material that is used for the method for forming the coating layer on the sliding section of a sliding member (for example, the eccentric section 208) in the compressor according to Embodiment 2 has a molybdenum disulfide content of 95 wt % or more and an average particle diameter of 8 μm as described above. In the method for forming the coating layer according to Embodiment 2, as in the case of Embodiment 1, first, the projecting material is heated at 450° C. so that the organic material content thereof is reduced to 1500 ppm or less in weight ratio. Since the method for forming the coating layer according to Embodiment 2 is the same as the above-mentioned method for forming the coating layer according to Embodiment 1, the method will be described below referring to the above-mentioned FIG. 4.

The molybdenum disulfide projecting material having an organic material content of 1500 ppm or less in weight ratio as described above and maintained at a temperature of 100° C. or more is projected onto the sliding face of the sliding section of a sliding member made of metal (for example, the surface of the eccentric section 208) at a speed of 100 m/s or more, together with a carrier gas, such as dry air, whereby the molybdenum disulfide is collided with the sliding face made of metal (refer to FIG. 4(a)).

When the molybdenum disulfide projecting material is projected onto the surface of the sliding section as described above, the kinetic energy of the molybdenum disulfide projecting material collided with the surface of the sliding section is converted into thermal energy (refer to FIG. 4(b)). As a result, a surface modifying treatment performed by the collision of the molybdenum disulfide projecting material is carried out on the sliding face, and the coating layer 221 (the coating layer is indicated as the coating layer 128 in FIG. 4(c)) is formed.

The operation of the rolling piston compressor wherein the coating layer 221 is formed on the sliding section of the sliding member as described above will be described below.

The electric power from a power supply (not shown) is supplied to the electric driving unit 205, and the rotor 204 of the electric driving unit 205 is rotated. The shaft 211 is rotated by the rotation of the rotor 204, and the rolling piston 216 loosely fitted on the eccentric section 208 of the shaft 211 rolls inside the compression chamber 212. As a result, the volume ratio between the high-pressure side and the low-pressure side of the compression chamber 212 is changed continuously, and the refrigerant 202 is thus compressed continuously. The compressed refrigerant 202 is discharged once into the hermetically sealed container 201, and a high-pressure atmosphere is achieved inside the hermetically sealed container 201. Since the pressure inside the hermetically sealed container 201 is high, the atmospheric pressure inside the hermetically sealed container 201 acts on the vane 217 as a back pressure, thereby pressing the tip of the vane 217 against the outer circumferential surface of the rolling piston 216.

In addition, the refrigerant 202 compressed inside the compression chamber 212 is discharged into the hermetically sealed container 201 and then fed from the discharge tube 223 into the refrigeration cycle (not shown). Furthermore, the refrigerant is circulated inside the refrigeration cycle and introduced again into the hermetically sealed container 201 through the suction tube 222. Moreover, by the rotation of the shaft 211, the oil supply spring 220 loosely fitted in the oil supply tube 219 continuously supplies the oil 207 to respective sliding sections.

Since the compressor according to Embodiment 2 is a rolling piston compressor, the rolling piston 216 is loosely fitted on the eccentric section 208 so as to be rotatable. Hence, the relative speed between the rolling piston 216 and the eccentric section 208 is lower than the relative speed between the main shaft 209 and the main bearing 214 and the relative speed between the auxiliary shaft 210 and the auxiliary bearing 215. This means that the Sommerfeld number S (represented by the following expression (1)) obtained using the bearing radius R, the bearing clearance C, the shaft rotation speed N, the oil viscosity μ and the face pressure P of the bearing, and indicating the characteristic of a journal bearing becomes smaller, resulting in a disadvantageous condition in which metal-to-metal contact is apt to occur in slide lubrication.

S=μ×N/P×(R/C)² (1)

Furthermore, in the rolling piston compressor, since a condensation pressure is generally generated inside the hermetically sealed container 201 the compressor has a structure in which its internal pressure is high and the refrigerant 202 is apt to be dissolved into the oil 207. This structure lowers the viscosity of the oil 207. When the viscosity of the oil 207 is lowered, the Sommerfeld number S indicating the characteristic of the journal bearing described above becomes smaller, resulting in a disadvantageous condition in slide lubrication.

However, in the rolling piston compressor according to Embodiment 2, even in the disadvantageous condition in slide lubrication in which the Sommerfeld number S represented by the expression (1) becomes smaller, since the coating layer 221 is formed by projecting the molybdenum disulfide projecting material onto the surfaces of the sliding sections of the eccentric section 208, the main shaft 209 and the auxiliary shaft 210 of the shaft 211, the molybdenum disulfide has a property of being cleaved in the sliding direction, and the size of its molecule is small, approximately 6×10⁻⁴ μm. As a result, in the compressor according to Embodiment 2, the friction coefficient of the sliding section becomes low, and the sliding loss is reduced. Hence, the compressor has high efficiency and high reliability.

As described in the above-mentioned Embodiment 1, the organic material content contained in the molybdenum disulfide projecting material similarly significantly affects the concentration of the molybdenum disulfide on the surface of the sliding section and the peeling of the coating layer 221 in the configuration of Embodiment 2.

More specifically, when the organic material content contained in the molybdenum disulfide projecting material was 1500 ppm or more in weight ratio, the concentration of the molybdenum disulfide on the surface of the shaft 211 after the projection treatment was apt to lower. It seems that this is caused by the fact that since the average particle diameter of the molybdenum disulfide is small, 8 μm, when the molybdenum disulfide was projected, the molybdenum disulfide interfered with the organic material, the projection orbit was varied, and the concentration of the molybdenum disulfide on the surface of the shaft 211 was reduced. Furthermore, when a reliability test was conducted, it was verified that no peeling phenomenon was caused when the organic material content contained in the molybdenum disulfide projecting material was 1500 ppm or less in weight ratio (refer to TABLE 1).

Since the coating layer forming method according to Embodiment 2 is the same as the coating layer forming method according to above-mentioned Embodiment 1, the coating layer 221 formed in the compressor according to Embodiment 2 is a stable film in which the metallic surface is modified and the molybdenum disulfide has a desired concentration as in the coating layer 128 formed in the compressor according to Embodiment 1. Furthermore, the coating layer 221 according to Embodiment 2 produces an effect similar to the effect of the coating layer 128 according to Embodiment 1.

It can be assumed that the configuration according to Embodiment 2 suppresses the energy generated at the time of the projection and collision from being used for the organic material and for the chemical reaction of the organic material and the projecting material, thereby suppressing the energy for surface modification from being reduced. Furthermore, it can be assumed that the configuration suppresses the organic material physically adsorbed to the molybdenum disulfide projecting material from being desorbed at the time of the projection, thereby suppressing the energy from being consumed owing to the desorption of the organic material and suppressing the energy for surface modification from being reduced.

The molybdenum disulfide projecting material serving as a projecting material is heated at 450° C. or less for a short time so that the organic material is burnt and removed. As a result, the molybdenum disulfide is prevented from being oxidized, whereby the organic material interrupting stable surface modification can be removed without losing the solid lubrication function inherent in the molybdenum disulfide.

Since the organic material is burnt as described above so that the organic material content is reduced to 1500 ppm or less, when the molybdenum disulfide projecting material is projected onto the surface of a sliding section of a sliding member made of metal, such as the shaft 211, the molybdenum disulfide projecting material prevents abrasion and provides a highly reliable sliding member.

In addition, in the coating layer forming method, the molybdenum disulfide projecting material is projected onto the surface of the sliding section while its temperature is maintained at a temperature of 100° C. or more. Hence, the molybdenum disulfide particles are suppressed from adhering to each other owing to the dew condensation occurred inside the projection cycle and the moisture slightly contained in the carrier gas. As a result, the energy loss owing to the adhesion at the time of the projection is prevented from increasing.

Furthermore, by maintaining the molybdenum disulfide projecting material at a temperature of 100° C. or more, any oil mist mixed in the carrier gas or air can be suppressed from being mixed into the molybdenum disulfide projecting material, whereby a stable film can be formed. Moreover, since the molybdenum disulfide projecting material is heated in advance and projected, a stable film can be formed by applying a small amount of projection energy. Besides, by raising the temperature of the molybdenum disulfide projecting material to 450° C., even if any oil mist is mixed in the carrier gas or air, the possibility of the mixture of the oil mist into the molybdenum disulfide projecting material can be reduced further.

In addition, even if the molybdenum disulfide is heated at 450° C., if the heating time is short (for example, one minute or less), the adverse effect of changing the lubricating function of the molybdenum disulfide owing to oxidation reaction can be ignored. For this reason, even when the molybdenum disulfide projecting material to which oil having a high boiling point (for example, 400° C.), such as rust-inhibiting oil, is attached, is heated, the organic material content can be adjusted to 1500 ppm or less.

Furthermore, in the coating layer forming method according to Embodiment 2, although the molybdenum disulfide projecting material having an average particle diameter of 8 μm is used, a similar effect is obtained, provided that the average particle diameter is in the range of 1 μm or more to 50 μm or less. According to experiments conducted by the inventors, it has been verified that if the average particle diameter is less than 1 μm, even if the molybdenum disulfide projecting material is projected onto the surface of a sliding member, no film is formed in many cases. It seems that if the average particle diameter is less than 1 μm, the energy generated when the molybdenum disulfide projecting material is collided with the surface of the sliding member becomes too small. Still further, if the average particle diameter is more than 50 μm, when the coating layer was formed by projecting the molybdenum disulfide projecting material onto the surface of the sliding member and when the sliding member was installed in the compressor, the effect of the coating layer was not produced in some cases. It seems that this is because the surface roughness of the surface of the sliding member increases, and it becomes difficult to obtain the effect of reducing the friction coefficient.

Furthermore, in Embodiment 2, although an example in which the coating layer 221 is formed by projecting the molybdenum disulfide projecting material onto the surfaces of the sliding sections of the eccentric section 208, the main shaft 209 and the auxiliary shaft 210, that is, one of the sliding faces of the mutually sliding sections of each pair of sliding members, has been described, the coating layer may also be formed on the inner circumferential surface of the rolling piston 216, and the surfaces of the sliding sections of the main bearing 214 and the auxiliary bearing 215, that is, the other sliding face of the mutually sliding sections, or the coating layers 221 may also be formed on both the sliding face of the eccentric section 208 and the inner circumferential surface of the rolling piston 216, both the sliding faces of the main shaft 209 and the main bearing 214, and both of the sliding faces of the auxiliary shaft 210 and the auxiliary bearing 215. Higher abrasion resistance is obtained by forming the coating layers 221 on both the sliding faces of the mutually sliding sections of the sliding members as described above.

Moreover, in Embodiment 2, although an example in which the coating layer 221 is formed on the surface of the sliding section of the shaft 211 has been described in detail, an effect similar to the effect described is produced when the coating layer 221 is formed by projecting the molybdenum disulfide projecting material onto the surfaces of other mutually sliding sections of the sliding members of the compressor, for example, the rolling piston 216 and the vane 217; the main bearing 214 and the vane 217; the auxiliary bearing 215 and the vane 217; the main bearing 214 and the rolling piston 216; the auxiliary bearing 215 and the rolling piston 216; the cylinder 213 and the vane 217; the cylinder 213 and the rolling piston 216; and the oil supply tube 219 and the oil supply spring 220.

Still further, in the compressor according to Embodiment 2 of the present invention, a similar effect is obtained when R600a or R290 or a mixed solvent of these or a refrigerant selected from the group consisting of R134a, R152, R407C, R404A and R410 is used as the refrigerant 202.

As the inverter technology is applied to compressors in recent years, compressor operation speed becomes lower. In particular, during a very low speed operation at less than 20 Hz, there is a growing problem that metal-to-metal contact occurs between the sliding sections of sliding members and that abnormal abrasion is caused. This problem of abnormal abrasion during the very low speed operation is solved by forming the coating layer described in Embodiment 2 on the surfaces of the sliding sections of the sliding members of a compressor operating at variable speed, although a compressor operating at constant speed has been described in Embodiment 2. As a result, the effect of the coating layer is produced significantly.

As described above in Embodiment 2 of the present invention, a highly reliable sliding member can be provided by forming the coating layer on the surface of the sliding section thereof using the molybdenum disulfide projecting material serving as a sliding face modification material, and the compressor incorporating the sliding member has high reliability. As a result, it is possible to provide an apparatus capable of carrying out compression at high efficiency.

Since the organic material content contained in the molybdenum disulfide projecting material serving as a sliding face modification material according to Embodiment 2 of the present invention is limited to 1500 ppm or less in weight ratio, when the projecting material is projected onto the surface of a sliding section by applying wind pressure or the like, the probability that the organic material is attached to the surface of the sliding section of the sliding member earlier than the molybdenum disulfide is reduced. Hence, the adverse effect of allowing the organic material to serve as a cushioning material and weakening the force of the molybdenum disulfide being collided with the surface of the sliding section can be reduced.

In addition, the use of the molybdenum disulfide projecting material serving as a sliding face modification material according to Embodiment 2 of the present invention can suppress the energy generated at the time of the projection and collision from being used for the organic material and for the chemical reaction of the organic material and the projecting material, thereby suppressing the energy for surface modification from being reduced. Furthermore, the sliding face modification material can suppress the organic material physically adsorbed to the molybdenum disulfide projecting material from being desorbed at the time of the projection, thereby suppressing the energy from being consumed owing to the desorption of the organic material and suppressing the energy for surface modification from being reduced.

Furthermore, the molybdenum disulfide projecting material serving as a sliding face modification material according to Embodiment 2 is obtained by heating a molybdenum disulfide material serving as the raw material of the projecting material at 450° C. or less so that the organic material contained therein is burnt and removed. Since the molybdenum disulfide material is heated for a short time, the molybdenum disulfide is prevented from being oxidized. Hence, the organic material interrupting stable coating layer formation is removed without losing the solid lubrication function inherent in the molybdenum disulfide.

In addition, since the molybdenum disulfide projecting material serving as a sliding face modification material according to Embodiment 2 has an average particle diameter in the range of 1 μm or more to 50 μm or less and has an organic material content of 1500 ppm or less, when the projecting material is projected by applying wind pressure or the like, the molybdenum disulfide is prevented from interfering with the organic material, whereby the projection orbit of the molybdenum disulfide is prevented from being varied.

Furthermore, since the molybdenum disulfide projecting material serving as a sliding face modification material according to Embodiment 2 is projected onto the surface of the sliding section as a target while the projecting material is heated at 100° C. or more, mutual adhesion of the molybdenum disulfide particles owing to the moisture contained in the projection cycle is reduced. As a result, the energy loss owing to the adhesion at the time of the projection is prevented from increasing. Moreover, by projecting the molybdenum disulfide projecting material serving as a sliding face modification material while its temperature is maintained at a higher temperature, the possibility of mixing any oil mist contained in the carrier gas or air with the molybdenum disulfide projecting material can be lowered, and a stable film can be formed. Still further, since the molybdenum disulfide projecting material serving as a sliding face modification material is heated in advance, a stable film can be formed by applying a small amount of projection energy.

In addition, since the process of forming the film of molybdenum disulfide is carried out by projecting the molybdenum disulfide projecting material onto the sliding face of the sliding section of a sliding member according to Embodiment 2, such as the piston, the molybdenum disulfide is cleaved at a low friction coefficient and performs solid lubrication action. As a result, the friction coefficient of the sliding face becomes low, and the sliding loss can be reduced.

Furthermore, in the rolling piston compressor incorporating the sliding members according to Embodiment 2 of the present invention, the molybdenum disulfide projecting material is projected onto the sliding face of at least one of the sliding members made of metallic materials and selected from the group consisting of the shaft, the cylinder, the rolling piston, the vane, the main bearing, the auxiliary bearing, the oil supply spring and the oil supply tube, thereby forming a coating layer. Hence, the molybdenum disulfide performs solid lubrication action, whereby the friction coefficient of the sliding member becomes low, and an excellent effect capable of remarkably reducing sliding loss is produced. Therefore, a compressor having a rotary compression unit being high in reliability and efficiency can be provided according to Embodiment 2 of the present invention.

### Embodiment 3

Next, a reciprocating compressor according to Embodiment 3 of the present invention will be described below referring to the accompanying drawings. Since the internal configuration of the reciprocating compressor according to Embodiment 3 is substantially the same as that of the compressor according to Embodiment 1 shown in the above-mentioned FIG. 1, the compressor according to Embodiment 3 will be described below referring to FIG. 1.

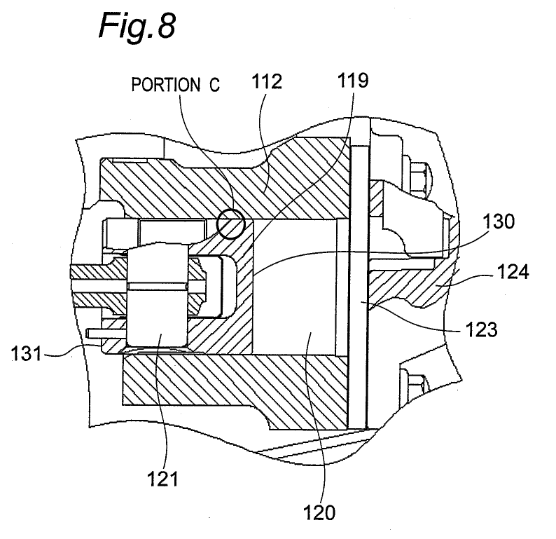

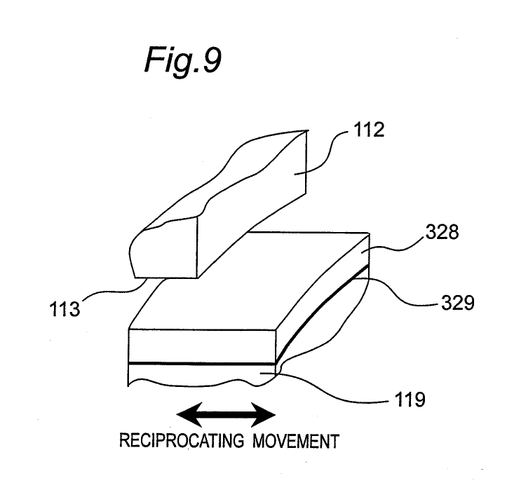

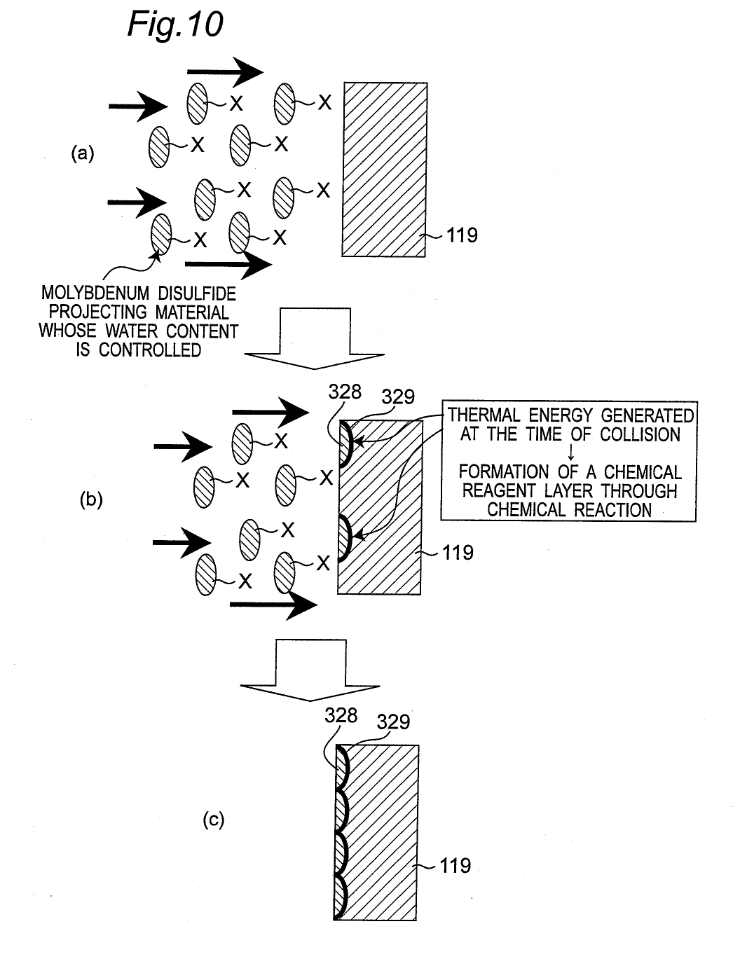

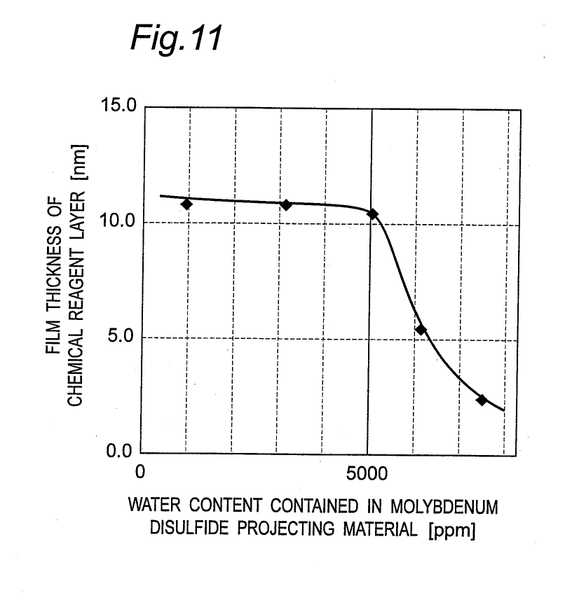

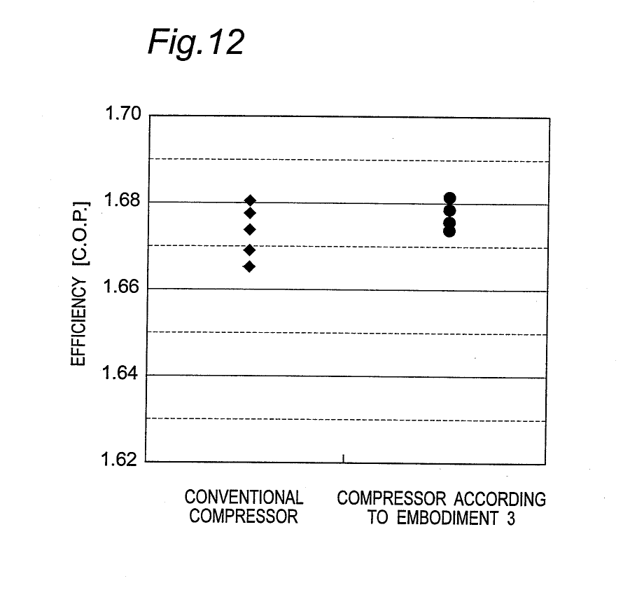

FIG. 8 is an enlarged sectional view showing a portion corresponding to the portion indicated by letter A in the compressor shown in FIG. 1. FIG. 9 is an enlarged perspective view showing a portion indicated by letter C in FIG. 8. FIG. 10 is a schematic view showing a method for forming a coating layer on the sliding section of a sliding member of the compressor according to Embodiment 3. FIG. 11 is a graph showing the relationship between the water content contained in the molybdenum disulfide projecting material serving as a sliding face modification material and the film thickness of a chemical reaction layer. FIG. 12 is a view showing the characteristics of the reciprocating compressor according to Embodiment 3 and the conventional compressor.

As in the reciprocating compressor according to Embodiment 1 shown in FIG. 1, in the reciprocating compressor according to Embodiment 3, a refrigerant 102 consisting of R600a or R134a is filled in a hermetically sealed container 101, and oil 103 is stored in the bottom section thereof. In addition, an electric driving unit 106 comprising a stator 104 and a rotor 105, and a reciprocating compression unit 107 driven using this electric driving unit 106 are accommodated in the hermetically sealed container 101. In the compression unit 107, the refrigerant 102 introduced into the hermetically sealed container 101 through a suction tube 125 is suctioned via a suction muffler 127 and compressed. The compressed refrigerant 102 is fed to a refrigeration cycle serving as a refrigerant circulation system through a discharge tube (not shown).

Since the configuration of the compression unit 107 in the reciprocating compressor according to Embodiment 3 is the same as that of the reciprocating compressor according to Embodiment 1, the description of the configuration is herein omitted.

In the compressor according to Embodiment 3 configured as described above, mutually sliding sections are formed between the sliding members of the compressor, that is, between the piston 119 and the cylinder block 112, between the main shaft 109 and the bearing section 114, between the thrust face 116 of the bearing section 114 and the thrust washer 117, between the piston pin 121 and the connecting rod 122, and between the eccentric shaft 110 and the connecting rod 122. A coating layer 328 is formed on the surface of at least one of the sliding sections. This coating layer 328 is formed by projecting and solid-dissolving a molybdenum disulfide projecting material having an average particle diameter of 8 μm and a molybdenum disulfide content of 95 wt % or more.

The coating layer 328 of the sliding section in the compressor according to Embodiment 3 will be described below in detail by taking an example in which the coating layer 328 is formed on the sliding face of the piston 119.

The molybdenum disulfide projecting material is solid-dissolved onto the sliding face of the piston 119 among the mutually sliding sections of the piston 119 and the inner face of the cylinder bore 113 of the cylinder block 112, and the coating layer 328 is formed.

FIG. 10 is a schematic view showing a method for forming the coating layer 328 on the surface of a sliding section using the molybdenum disulfide projecting material. In Embodiment 3, a method is used in which the molybdenum disulfide projecting material whose water content is controlled is collided with the sliding face of a sliding member at a predetermined speed, together with a gas, such as dry air.

In the coating layer forming method according to Embodiment 3, the projecting material has a molybdenum disulfide content of 95 wt % or more and an average particle diameter of 8 μm. In addition, the water content contained in the molybdenum disulfide before projection is 5000 ppm or less in weight ratio. The conditions for the projection are that the pressure of the projection is in the range of 0.5 MPa or more to 3.0 MPa or less, and that the amount of the projection is in the range of 100 g/min or more to 300 g/min or less. In the piston 119 serving as a sliding member formed using this coating layer forming method, a chemical reaction layer 329 composed of iron, carbon, molybdenum and sulfur is formed between the coating layer 328 and the base material of the sliding member (refer to FIG. 9).

In the coating layer forming method, first, a molybdenum disulfide projecting material X having a water content of 5000 ppm or less in weight ratio, an average particle diameter of 8 μm and a molybdenum disulfide content of 95 wt % or more is produced. The molybdenum disulfide projecting material X produced as described above is projected onto the sliding face of a sliding member made of metal (for example, the surface of the piston 119) at the pressure of the projection in the range of 0.5 MPa or more to 3.0 MPa or less and the amount of the projection in the range of 100 g/min or more to 300 g/min or less, together with a carrier gas, such as dry air, whereby the molybdenum disulfide projecting material X is collided with the sliding face (refer to FIG. 10(a)). The projection amount of the molybdenum disulfide projecting material X is preferably required to be at least 100 g/min or more, although the preferable amount differs depending on the material of the sliding face onto which the material is projected. If the projection amount is smaller than 100 g/min, the thermal energy at the time when the molybdenum disulfide projecting material X is collided with the sliding face becomes insufficient, and the coating layer 328 may not be formed properly in some cases.

When the molybdenum disulfide projecting material X is projected onto the surface of the sliding section as described above, the kinetic energy of the molybdenum disulfide projecting material X collided with the surface of the sliding section is converted into thermal energy (refer to FIG. 10(b)). As a result, a surface modifying treatment performed by the collision of the molybdenum disulfide projecting material X is carried out on the sliding face, and the coating layer 328 and the chemical reaction layer 329 are formed on the base material of the sliding member.

Since the operation of the reciprocating compressor according to Embodiment 3 in which the coating layer 328 is formed on the sliding member as described above is the same as the operation of the reciprocating compressor according to the above-mentioned Embodiment 1, the description of the operation is herein omitted.

In the conventional compressor, when the piston reciprocates inside the cylinder bore, since the clearance between the piston and the cylinder bore is very small, mutually contacting portions are present partially owing to variations in shape and accuracy of the piston and the cylinder bore. However, in the compressor according to Embodiment 3 of the present invention, since the molybdenum disulfide being used as the projecting material has a property of cleaving in the sliding direction and the coating layer 328 of the molybdenum disulfide has a layer lattice structure, the coating layer 328 has a property of being apt to slide easily with low shearing force. As a result, with the configuration of the compressor according to Embodiment 3, the friction coefficient of the sliding face becomes low, and the sliding loss is reduced, whereby it is possible to provide a compressor having high reliability and high efficiency.

In addition, in the compressor according to Embodiment 3 of the present invention, the adhesiveness between the coating layer 328 and a sliding member, for example, the base material of the piston 119, is high, and the coating layer 328 is rarely peeled from the base material of the piston 119. Hence, the sliding sections of the piston 119 and the cylinder bore 113 are hardly abraded. As a result, in the compressor according to Embodiment 3, expansion of the clearance between the piston 119 and the cylinder bore 113 due to abrasion is suppressed, and the leakage amount of the compressed refrigerant 102 from the clearance between the piston 119 and the cylinder bore 113 is reduced significantly. As a result, with the configuration according to Embodiment 3, it is possible to provide a compressor having high reliability and high efficiency. The efficiency of the compressor according to the present invention configured described above will be described later.

Next, the chemical reaction layer 329 for raising the adhesion strength between the coating layer 328 of molybdenum disulfide and the base material of the sliding member will be described below referring to FIG. 11. FIG. 11 is a graph showing the relationship between the water content contained in the molybdenum disulfide projecting material serving as a sliding face modification material and the film thickness of the chemical reaction layer 329. In FIG. 11, the horizontal axis represents the water content[ppm] contained in the molybdenum disulfide projecting material, and the vertical axis represents the film thickness [nm] of the chemical reaction layer 329 formed on the sliding face of the sliding member.

As shown in FIG. 11, it can be understood that if the molybdenum disulfide projecting material contains a water content of more than 5000 ppm in weight ratio, the film thickness of the chemical reaction layer 329 decreases abruptly. Hence, it can also be understood that the chemical reaction layer 329 having a stable film thickness can be formed and that high adhesion strength can be obtained securely between the coating layer 328 and the base material of the sliding member by suppressing the water content contained in the molybdenum disulfide projecting material to 5000 ppm or less in weight ratio. Furthermore, it has been verified through experiment that this high adhesion strength is obtained securely under the conditions that the average particle diameter of the molybdenum disulfide projecting material is 50 μm or less, that the pressure of the projection is in the range of 0.5 MPa or more to 3.0 MPa or less, and that the amount of the projection is in the range of 100 g/min or more to 300 g/min or less.

Aggregation of the molybdenum disulfide powder owing to water content can be prevented by reducing the water content contained in the molybdenum disulfide projecting material. Furthermore, the speed of the molybdenum disulfide powder can be accelerated sufficiently without aggregation by projecting the molybdenum disulfide projecting material under the conditions that the pressure of the projection is in the range of 0.5 MPa or more to 3.0 MPa or less, and that the amount of the projection is in the range of 100 g/min or more to 300 g/min or less.

Hence, almost all the kinetic energy generated by projecting the molybdenum disulfide projecting material can be supplied to the sliding member. Then, the kinetic energy is converted into thermal energy, the heat of the molybdenum disulfide projecting material is dissipated to the sliding member, the reaction between the molybdenum disulfide projecting material and the sliding member is accelerated, and the chemical reaction layer 329 composed of iron, carbon, molybdenum and sulfur and having a stable film thickness is formed between the coating layer 328 and the sliding member.

The chemical reaction layer 329 formed as described above serves as a binder between a sliding member, such as the piston 119, and the coating layer 328 and can raise the adhesion strength between the coating layer 328 in which the molybdenum disulfide is solid-dissolved and the base material of a sliding member, such as the piston 119. As a result, it is possible to form the coating layer 328 having very high adhesion strength to the base material of the sliding member.

In Embodiment 3 according to the present invention, the molybdenum disulfide projecting material serves as a sliding face modification material is stored in a place where the humidity is set to 50% or less, preferably in the range of 30% or more to 40% or less, and the temperature is set in the range of 19° C. or more to 35° C. or less. In addition, when the molybdenum disulfide projecting material was stored for seven days in the above-mentioned storage place, the water content decreased from 2856 ppm to 1215 ppm, but no change was recognized in the organic material content contained in the molybdenum disulfide projecting material. The organic material is basically defined as compounds containing C and H, oils, such as hydraulic oil, dust, and dirt.

When the molybdenum disulfide projecting material serving as a sliding face modification material was stored under the above-mentioned predetermined conditions, the water content was easily decreased to 5000 ppm or less in weight ratio. On the other hand, when the molybdenum disulfide projecting material was stored for seven days in an ordinary storehouse where the above-mentioned storage conditions are not set, it was verified that the water content exceeded 5000 ppm.

Next, the characteristic of a compressor incorporating a sliding member on which the coating layer 328 is formed by projecting the molybdenum disulfide projecting material according to Embodiment 3 of the present invention will be described below.

FIG. 12 is a graph showing the characteristic of the compressor incorporating the sliding member according to Embodiment 3 of the present invention in comparison with that of the conventional compressor. In FIG. 12, the vertical axis represents efficiency [C.O.P. (coefficient of performance)]. The right side indicates the efficiency of the compressor according to Embodiment 3 of the present invention, and the left side indicates the efficiency of the conventional compressor.

In the compressor according to Embodiment 3 of the present invention, the piston 119 is incorporated as a sliding member on which the coating layer 328 and the chemical reaction layer 329 are formed by projecting the molybdenum disulfide projecting material. In addition, the clearance between the piston 119 and the cylinder bore 113 in the compressor according to Embodiment 3 is made equal to the clearance between the piston and the cylinder bore of the conventional compressor.

As clearly shown in FIG. 12, it is found that the efficiency of the compressor according to Embodiment 3 of the present invention has small variations and a high average value in comparison with the efficiency of the conventional compressor.

In the reciprocating compressor shown in FIG. 1, when the piston 119 reaches its top dead center and bottom dead center, its speed becomes zero, no hydraulic pressure is generated theoretically, and no oil film is formed. Hence, metal-to-metal contact may occur frequently between the piston 119 and the cylinder bore 113 at the top dead center and the bottom dead center of the piston 119.

Furthermore, when the piston 119 is near the top dead center, the piston 119 receives a large compression load due to the compressed high-pressure refrigerant. This compression load is transmitted to the crankshaft 108 via the piston pin 121 and the connecting rod 122, and the crankshaft 108 is pushed in a direction opposite to the movement direction of the piston 119 and inclined. When the crankshaft 108 is inclined, the piston 119 is inclined inside the cylinder bore 113. As a result, prying occurs between the upper end face side (the face side designated by numeral 130 in FIG. 8) and the lower end face side (the face side designated by numeral 131 in FIG. 8) of the piston 119, the piston 119 moves while making contact with the cylinder bore 113, and abrasion occurs.

However, in Embodiment 3 of the present invention, the adhesiveness between the coating layer 328 of molybdenum disulfide and the base material of the piston 119 is raised by virtue of the chemical reaction layer 329. Hence, the coating layer 328 is hardly peeled from the base material of the piston 119. In addition, since the coating layer 328 has a layer lattice structure, the coating layer has a structure being apt to slide easily with low shearing force, the friction coefficient at the sliding face of the sliding member becomes low, and the sliding loss is reduced significantly. As a result, with the configuration of the compressor according to Embodiment 3 of the present invention, it is possible to provide a compressor having high reliability and high efficiency.

In particular, in the reciprocating compressor having the cantilever bearing structure described in Embodiment 3, the above-mentioned inclination of the crankshaft 108 at the time when the piston 119 is near the top dead center becomes particularly large. Hence, with this structure, the contact and prying are caused between the piston 119 and the cylinder bore 113, abrasion occurs markedly, and the load to the coating layer 328 becomes large. However, even in this high load condition, since the piston 119 has the coating layer 328 and the chemical reaction layer 329 described in Embodiment 3, the excellent effect that the coating layer 328 is hardly peeled is produced sufficiently.

Furthermore, in Embodiment 3, although the molybdenum disulfide projecting material having an average particle diameter of 8 μm is used, a similar effect is obtained, provided that the average particle diameter of solid lubrication powder is 50 μm or less. If the average particle diameter is more than 50 μm, even if a sliding member on which the coating layer was formed by projecting the molybdenum disulfide projecting material onto the surface thereof was incorporated in a compressor, the effect was not produced in some cases when the compressor was operated. It seems that this is because the surface roughness of the surface of the sliding member increases, and it becomes difficult to obtain the effect of reducing the friction coefficient.

As the inverter technology is applied to compressors, compressor operation speed becomes lower. In particular, during a very low speed operation at less than 20 Hz, it is further difficult to establish fluid lubrication, and metal-to-metal contact is apt to occur. However, the effect of Embodiment 3 is significantly produced by using the sliding member according to Embodiment 3 for a compressor capable of performing a very low speed operation, although a reciprocating compressor operating at a constant speed has been described in Embodiment 3.

In Embodiment 3, although the coating layer 328 is formed by solid-dissolving molybdenum disulfide onto the surface of the sliding section of the piston 119, the coating layer 328 may also be formed on the surface of the sliding section of the cylinder bore 113. Furthermore, the coating layer 328 may also be formed on both the sliding sections of the piston 119 and the cylinder bore 113. When the coating layer 328 is formed on both the sliding sections of the piston 119 and the cylinder bore 113, higher abrasion resistance is obtained.

Moreover, in Embodiment 3, although an example in which the coating layer 328 is formed by solid-dissolving molybdenum disulfide on the surface of the sliding section of the piston 119 has been described in detail, even when the coating layer 328 is formed on the mutually sliding sections of the sliding members, for example, the main shaft 109 of the crankshaft 108 and the bearing section 114; the flange face 115 of the rotor 105 and the thrust washer 117; the thrust face 116, that is, the upper end face of the bearing section 114, and the thrust washer 117; the piston pin 121 and the connecting rod 122, and the eccentric shaft 110 and the connecting rod 122, an excellent effect similar to the effect described in the configuration of Embodiment 1 is obtained.

Besides, in Embodiment 3, although an example in which the thrust bearing section 118 serving as a sliding member between the rotor 105 and the bearing section 114 comprises the flange face 115, the thrust face 116 and the thrust washer 117 disposed therebetween has been described, the thrust bearing section may be provided at another position. For example, the thrust bearing section may be configured by forming the flange face 115A of the crankshaft 108 at the position opposed to the bearing section 114 in the flange section 129 formed between the main shaft 109 of the crankshaft 108 and the eccentric shaft 110 and by forming a thrust face 116A at the position of the bearing section 114 sliding against the flange face 115A. In this case, an effect similar to the effect described in Embodiment 3 is produced by forming the coating layer 328 on at least one of the sliding sections.

Still further, in the compressor according to Embodiment 3 of the present invention, a similar effect is obtained in the sliding sections when R600a or R290 or a mixed solvent of these or a refrigerant selected from the group consisting of R134a, R152, R407C, R404A and R410 is used as the refrigerant 102.

As described above in Embodiment 3 of the present invention, a highly reliable sliding member can be provided by forming the coating layer and the chemical reaction layer on the surface of the sliding section thereof using the molybdenum disulfide projecting material serving as a sliding face modification material, and the compressor incorporating the sliding member has high reliability and can carry out compression at high efficiency.

### Embodiment 4

Next, a rolling piston compressor according to Embodiment 4 of the present invention will be described below referring to the accompanying drawings. Since the internal configuration of the rolling piston compressor according to Embodiment 4 is substantially the same as that of the compressor according to Embodiment 2 shown in the above-mentioned FIGS. 5 and 6, the compressor according to Embodiment 4 will be described below referring to FIGS. 5 and 6.

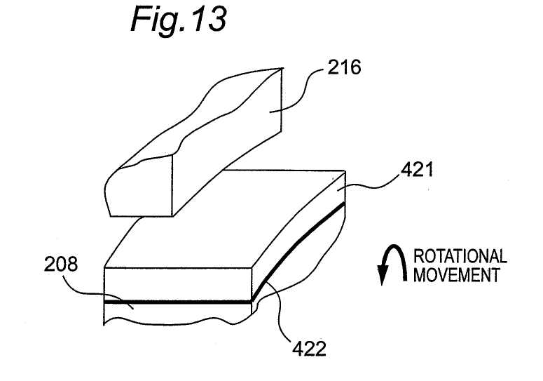

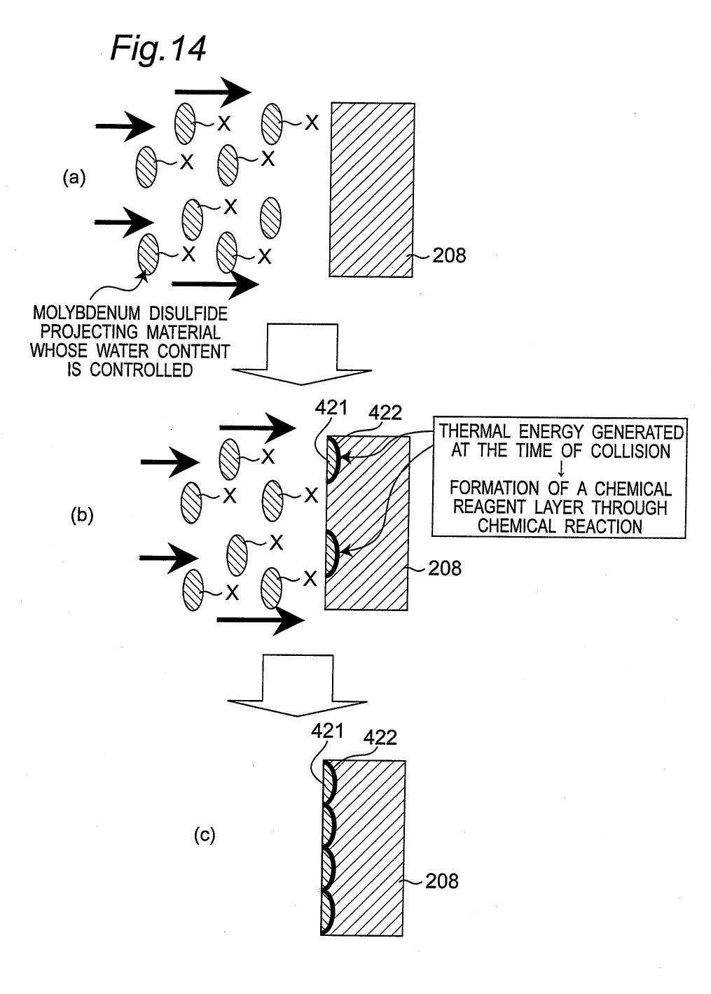

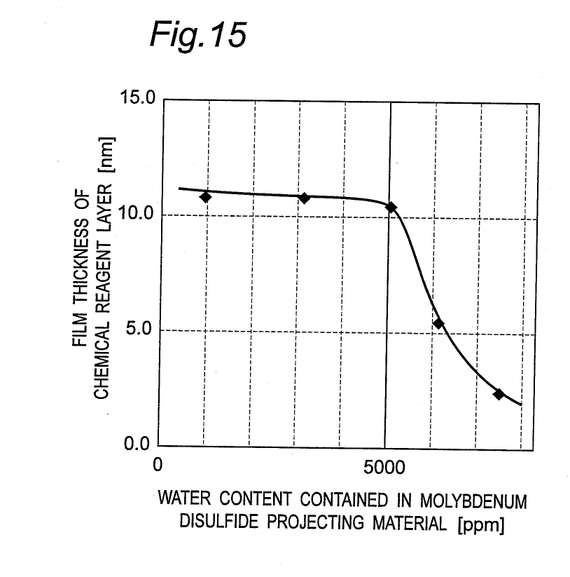

FIG. 13 is an enlarged perspective view showing the sliding sections according to Embodiment 4 corresponding to portion E in FIG. 6. FIG. 14 is a view illustrating a method for forming a coating layer of molybdenum disulfide according to Embodiment 4. FIG.15 is a graph showing the relationship between the water content contained in the molybdenum disulfide projecting material serving as a sliding face modification material and the film thickness of a chemical reaction layer.

As shown in FIGS. 5 and 6, in the rolling piston compressor according to Embodiment 4, a hermetically sealed container 201 is filled with a refrigerant 202. In addition, an electric driving unit 205 comprising a stator 203 and a rotor 204, a rolling piston compression unit 206 driven using the electric driving unit 205, and oil 207 are accommodated inside the hermetically sealed container 201.

Since the configuration of the compression unit 206 in the rolling piston compressor according to Embodiment 4 is the same as that of the compressor according to Embodiment 2, the description of the configuration is herein omitted.

In the rolling piston compressor according to Embodiment 4, the molybdenum disulfide projecting material having an average particle diameter of 8 μm and a molybdenum disulfide content of 95 wt % or more is collided with and solid-dissolved onto the surfaces of the sliding sections of the eccentric section 208, the main shaft 209 and the auxiliary shaft 210 of the shaft 211, whereby a coating layer 421 of molybdenum disulfide is formed on each surface.

Next, a method for forming the coating layer 421 by projecting the molybdenum disulfide projecting material serving as a sliding face modification material according to Embodiment 4 of the present invention will be described below. The projecting material that is used for the method for forming the coating layer on the sliding section of a sliding member (for example, the eccentric section 208 shown in FIG. 6) in the compressor according to Embodiment 4 has a molybdenum disulfide content of 95 wt % or more and an average particle diameter of 8 μm as described above. In the method for forming the coating layer according to Embodiment 4, a method is used in which the molybdenum disulfide projecting material whose water content is controlled is collided with the sliding face of a sliding member at a predetermined speed, together with a gas, such as dry air.

In Embodiment 4, the water content contained in the molybdenum disulfide before projection is 5000 ppm or less in weight ratio. The conditions for the projection are that the pressure of the projection is in the range of 0.5 MPa or more to 3.0 MPa or less, and that the amount of the projection is in the range of 100 g/min or more to 300 g/min or less. In a sliding member formed using this coating layer forming method, a chemical reaction layer 422 composed of iron, carbon, molybdenum and sulfur is formed between the coating layer 421 and the base material of the sliding member (refer to FIG. 13).

In the coating layer forming method, first, a molybdenum disulfide projecting material X having a water content of 5000 ppm or less in weight ratio, an average particle diameter of 8 μm and a molybdenum disulfide content of 95 wt % or more is produced. The molybdenum disulfide projecting material X produced as described above is projected onto the sliding face of a sliding member made of metal (for example, the surface of the eccentric section 208) at the pressure of the projection in the range of 0.5 MPa or more to 3.0 MPa or less and the amount of the projection in the range of 100 g/min or more to 300 g/min or less, together with a carrier gas, such as dry air, whereby the molybdenum disulfide projecting material X is collided with the sliding face (refer to FIG. 14(a)). The projection amount of the molybdenum disulfide projecting material X is preferably required to be at least 100 g/min or more, although the preferable amount differs depending on the material of the sliding face onto which the material is projected. If the projection amount is smaller than 100 g/min, the thermal energy at the time when the molybdenum disulfide projecting material X is collided with the sliding face becomes insufficient, and the coating layer 421 may not be formed properly in some cases.

When the molybdenum disulfide projecting material X is projected onto the surface of the sliding section as described above, the kinetic energy of the molybdenum disulfide projecting material X collided with the surface of the sliding section is converted into thermal energy (refer to FIG. 14(b)). As a result, a surface modifying treatment performed by the collision of the molybdenum disulfide projecting material X is carried out on the sliding face, and the coating layer 421 and the chemical reaction layer 422 are formed on the base material of the sliding member (refer to FIG. 14(c)).

Since the operation of the rolling piston compressor according to Embodiment 4 in which the coating layer 421 is formed on the sliding member as described above is the same as the operation of the compressor according to the above-mentioned Embodiment 2, the description of the operation is herein omitted.

Since the compressor according to Embodiment 4 is a rolling piston compressor, the rolling piston 216 is loosely fitted on the eccentric section 208 so as to be rotatable. Hence, the relative speed between the rolling piston 216 and the eccentric section 208 is lower than the relative speed between the main shaft 209 and the main bearing 214 and the relative speed between the auxiliary shaft 210 and the auxiliary bearing 215. Hence, with this structure, oil film formation is relatively difficult and metal-to-metal contact is apt to occur.

Furthermore, in the rolling piston compressor, since a condensation pressure is generally generated inside the hermetically sealed container 201, the compressor has a structure in which its internal pressure is high and the refrigerant 202 is apt to be dissolved into the oil 207. This lowers the viscosity of the oil 207 and is disadvantageous in slide lubrication.

However, in Embodiment 4, since the adhesiveness of the coating layer 421 of molybdenum disulfide to the base material of the eccentric section 208 of the shaft 211 is raised by virtue of the chemical reaction layer 422, the coating layer 421 is hardly peeled. In addition, since the coating layer 421 has a layer lattice structure, the coating layer is apt to slide easily with low shearing force, and the friction coefficient of the sliding face becomes low, and the sliding loss is reduced. For this reason, a rolling piston compressor having high reliability and high efficiency can be provided by forming the coating layer 421 and the chemical reaction layer 422 according to Embodiment 4 on the sliding section of the sliding member.

The efficiency of the rolling piston compressor according to Embodiment 4 configured described above will be described later.

Next, the chemical reaction layer 422 for raising the adhesion strength between the coating layer 421 made of molybdenum disulfide and the base material of the sliding member will be described below referring to FIG. 15. FIG. 15 is a graph showing the relationship between the water content contained in the molybdenum disulfide projecting material serving as a sliding face modification material and the film thickness of the chemical reaction layer 422. In FIG. 15, the horizontal axis represents the water content[ppm] contained in the molybdenum disulfide projecting material, and the vertical axis represents the film thickness [nm] of the chemical reaction layer 422 formed on the sliding face of the sliding member.

As shown in FIG. 15, it can be understood that if the molybdenum disulfide projecting material contains a water content of more than 5000 ppm in weight ratio, the film thickness of the chemical reaction layer 422 decreases abruptly. Hence, it can also be understood that the chemical reaction layer 422 having a stable film thickness can be formed and that high adhesion strength can be obtained securely between the coating layer 421 and the base material of the sliding member by suppressing the water content contained in the molybdenum disulfide projecting material to 5000 ppm or less in weight ratio. Furthermore, it has been verified through experiment that this high adhesion strength is obtained securely under the conditions that the average particle diameter of the molybdenum disulfide projecting material is 50 μm or less, that the pressure of the projection is in the range of 0.5 MPa or more to 3.0 MPa or less, and that the amount of the projection is in the range of 100 g/min or more to 300 g/min or less.

Aggregation of the molybdenum disulfide powder owing to water content can be prevented by reducing the water content contained in the molybdenum disulfide projecting material. Furthermore, the speed of the molybdenum disulfide powder can be accelerated sufficiently without aggregation by projecting the molybdenum disulfide projecting material under the conditions that the pressure of the projection is in the range of 0.5 MPa or more to 3.0 MPa or less, and that the amount of the projection is in the range of 100 g/min or more to 300 g/min or less.

Hence, almost all the kinetic energy generated by projecting the molybdenum disulfide projecting material can be supplied to the sliding member. Then, the kinetic energy is converted into thermal energy, the heat of the molybdenum disulfide projecting material is dissipated to the sliding member, the reaction between the molybdenum disulfide projecting material and the sliding member is accelerated, and the chemical reaction layer 422 composed of iron, carbon, molybdenum and sulfur and having a stable film thickness is formed between the coating layer 421 made of molybdenum disulfide and the sliding member.

The chemical reaction layer 422 formed as described above serves as a binder between a sliding member, such as the eccentric section 208, and the coating layer 421 and can stably raise the adhesion strength between the coating layer 421 in which the molybdenum disulfide is solid-dissolved and the base material of a sliding member, such as the shaft 211. As a result, it seems that the coating layer 421 having very high adhesion strength to the base material of the sliding member was able to be formed.

Furthermore, in Embodiment 4, although the molybdenum disulfide projecting material having an average particle diameter of 8 μm is used, a similar effect is obtained, provided that the average particle diameter of solid lubrication powder is 50 μm or less. If the average particle diameter is more than 50 μm, even if a sliding member on which the coating layer was formed by projecting the molybdenum disulfide projecting material onto the surface thereof was incorporated in a compressor, the effect was not produced in some cases when the compressor was operated. It seems that this is because the surface roughness of the surface of the sliding member increases, and it becomes difficult to obtain the effect of reducing the friction coefficient.

As the inverter technology is applied to compressors, compressor operation speed becomes lower. In particular, during a very low speed operation at less than 20 Hz, it is further difficult to establish fluid lubrication, and metal-to-metal contact is apt to occur. However, the effect of Embodiment 4 is significantly produced by using the sliding member according to Embodiment 4 for a compressor performing a very low speed operation, although a rolling piston compressor operating at a constant speed has been described in Embodiment 4.

In Embodiment 4, although the coating layer 421 is formed by solid-dissolving molybdenum disulfide onto the sliding face of the eccentric section 208 of the shaft 211, the coating layer 421 may also be formed on the inner circumferential face of the rolling piston 216. Furthermore, the coating layer 421 may also be formed on both the sliding faces of the eccentric section 208 and the rolling piston 216. When the coating layer 421 is formed on both the sliding faces of the eccentric section 208 and the rolling piston 216, higher abrasion resistance is obtained.

Moreover, in Embodiment 4, although an example in which the coating layer 421 is formed by solid-dissolving molybdenum disulfide on the sliding face of the eccentric section 208 of the shaft 211 has been described in detail, a configuration in which the rotation of the shaft 211 is maintained more efficiently can be obtained by forming the coating layer 421 on the sliding faces of the main bearing 214 and the auxiliary bearing 215. Furthermore, the coating layer 421 may also be formed on both the mutually sliding sections of the main shaft 209 and the main bearing 214, and both the mutually sliding sections of the auxiliary shaft 210 and the auxiliary bearing 215. With this configuration, it is needless to say that a further excellent effect is produced.

Moreover, in the compressor according to Embodiment 4, an excellent effect is also obtained when the coating layer 421 is formed by solid-dissolving the molybdenum disulfide projecting material onto the surfaces of mutually sliding sections of the sliding members of the compressor, for example, the rolling piston 216 and the vane 217; the main bearing 214 and the vane 217; the auxiliary bearing 215 and the vane 217; the main bearing 214 and the rolling piston 216; the auxiliary bearing 215 and the rolling piston 216; the cylinder 213 and the vane 217; the cylinder 213 and the rolling piston 216; and the oil supply tube 219 and the oil supply spring 220.

Still further, in Embodiment 4 of the present invention, a similar effect is obtained in the sliding sections even when R600a or R290 or a mixed solvent of these or a refrigerant selected from the group consisting of R134a, R152, R407C, R404A and R410 is used as the refrigerant 202.

As described above in Embodiment 4 of the present invention, a highly reliable sliding member can be provided by forming the coating layer and the chemical reaction layer on the surface of the sliding section thereof using the molybdenum disulfide projecting material serving as a sliding face modification material, and the compressor incorporating the sliding member has high reliability. As a result, it is possible to obtain an apparatus capable of carrying out compression at high efficiency.

In the above-mentioned Embodiments, although examples in which sliding members are used for compressors have been described, the present invention is not particularly limited to compressors but can be applied to apparatuses comprising members having sliding faces and performing sliding operations. The present invention can remarkably reduce the friction coefficients of the sliding members of such apparatuses to which the present invention is applied.

Furthermore, in the above-mentioned Embodiments, although examples in which the sliding members are made of metal have been described, the sliding members are not limited to be made of metal. The present invention can be applied to sliding members made of materials, such as resin, glass and ceramic in a similar way.

### INDUSTRIAL APPLICABILITY

As described above, the present invention can decrease the friction coefficients of sliding members and can remarkably reduce sliding loss, thereby being useful for apparatuses having sliding members.

1. A sliding face modification material having a molybdenum disulfide content of 95 wt % or more and an organic material content of 1500 ppm or less in weight ratio, said sliding face modification material being projected onto a sliding face to form a coating layer.

2. The sliding face modification material according to claim 1, wherein the average particle diameter of the molybdenum disulfide is in the range of 1 μm or more to 50 μm or less.

3. A method for producing a sliding face modification material being characterized in that a material containing molybdenum disulfide is heated at 450° C. or less to burn and remove organic material contained in said material and to contain said organic material at 1500 ppm or less in weight ratio and the molybdenum disulfide at 95 wt % or more.

4. A method for using a sliding face modification material being characterized in that said sliding face modification material containing molybdenum disulfide at 95 wt % or more and containing organic material at 1500 ppm or less in weight ratio is projected in a state of being heated at 100° C. or more onto a sliding face to form a coating layer of molybdenum disulfide.

5. A sliding member being characterized in that a coating layer is formed thereon by projecting a sliding face modification material containing molybdenum disulfide at 95 wt % or more and containing organic material at 1500 ppm or less in weight ratio onto the sliding face thereof and by solid-dissolving the molybdenum disulfide.

6. A compressor for use in a system for circulating a refrigerant being characterized in that said sliding member according to claim 5 is used for at least one of members having sliding faces.

7. A compressor accommodating an electric driving unit and a compression unit inside a hermetically sealed container storing oil, and compressing a refrigerant,
said compression unit being a reciprocating type compression mechanism comprising:
a crankshaft having a main shaft to which the rotor of said electric driving unit is secured and an eccentric shaft,
a bearing section, having a thrust face for rotatably supporting said rotor, for rotatably journaling said main shaft of said crankshaft,
a cylinder block having a cylinder bore,
a piston reciprocating inside said cylinder bore,
a piston pin disposed in parallel with said eccentric shaft and secured to said piston, and
a connecting rod connecting said eccentric shaft to said piston via said piston pin,
wherein
said sliding member according to claim 5 is used for at least one of members of said crankshaft, said bearing section, said cylinder block, said piston, said piston pin and said connecting rod, having sliding faces.

8. A compressor accommodating an electric driving unit and a compression unit inside a hermetically sealed container storing oil, and compressing a refrigerant,
said compression unit being a rolling piston type compression mechanism comprising:
a shaft having a main shaft to which the rotor of said electric driving unit is secured, an eccentric section being eccentric from the rotation axis of said main shaft, and an auxiliary shaft protruding from said eccentric section and being parallel with said main shaft,
a cylinder defining a compression chamber having a cylindrical space being coaxial with the rotation axis of said shaft,
a rolling piston loosely fitted in said eccentric section and rolling inside said compression chamber,
a vane making contact with said rolling piston and dividing said compression chamber into a high-pressure side and a low-pressure side,
a main bearing for sealing one of side faces of said cylinder, that is, the side face on the side of said electric driving unit, and for journaling said main shaft of said shaft,
an auxiliary bearing for sealing the other side face of said cylinder and for journaling said auxiliary shaft of said shaft,
an oil supply spring secured to said auxiliary shaft, and
an oil supply tube accommodating said oil supply spring, the open end of which is disposed in said oil, wherein
said sliding member according to claim 5 is used for at least one of members of said shaft, said cylinder, said rolling piston, said vane, said main bearing, said auxiliary bearing, said oil supply spring and said oil supply tube, having sliding faces.

9. A sliding face modification material being characterized in that said sliding face modification material contains molybdenum disulfide at 95 wt % or more, that water content contained in the molybdenum disulfide is 5000 ppm or less in weight ratio, and that said sliding face modification material is projected onto a sliding face to form a coating layer of the molybdenum disulfide.

10. The sliding face modification material according to claim 9, wherein said sliding face modification material is solid lubrication powder in which the average particle diameter of the molybdenum disulfide is in the range of 1 μm or more to 50 μm or less.

11. A method for using a sliding face modification material being characterized in that said sliding face modification material containing molybdenum disulfide at 95 wt % or more, water content contained in the molybdenum disulfide being 5000 ppm or less in weight ratio, is projected onto a sliding face to form a coating layer of the molybdenum disulfide, wherein
the pressure of projecting said sliding face modification material is in the range of 0.5 MPa or more to 3.0 MPa or less, and the amount of the projection is in the range of 100 g/min or more to 300 g/min or less.

12. A sliding member being characterized in that said sliding face modification material according to claim 9 is projected onto the sliding face of said sliding member made of a metallic material to form a coating layer in which molybdenum disulfide is solid-dissolved.

13. A compressor being used for a system for circulating a refrigerant, wherein said sliding member according to claim 12 is used for at least one of members having sliding faces.

14. A compressor accommodating an electric driving unit and a compression unit inside a hermetically sealed container storing oil, and compressing a refrigerant,
said compression unit being a reciprocating type compression mechanism comprising:
a crankshaft having a main shaft to which the rotor of said electric driving unit is secured and an eccentric shaft,
a bearing section, having a thrust face for rotatably supporting said rotor, for rotatably journaling said main shaft of said crankshaft,
a cylinder block having a cylinder bore,
a piston reciprocating inside said cylinder bore,
a piston pin disposed in parallel with said eccentric shaft and secured to said piston, and
a connecting rod connecting said eccentric shaft to said piston via said piston pin, wherein
the sliding member according to claim 12 is used for at least one of members of said crankshaft, said bearing section, said cylinder block, said piston, said piston pin and said connecting rod, having sliding faces.

15. A compressor accommodating an electric driving unit and a compression unit inside a hermetically sealed container storing oil, and compressing a refrigerant,
the compression unit being a rolling piston type compression mechanism comprising:
a shaft having a main shaft to which the rotor of said electric driving unit is secured, an eccentric section being eccentric from the rotation axis of said main shaft, and an auxiliary shaft protruding from said eccentric section and being parallel with said main shaft,
a cylinder having a compression chamber having a cylindrical space being coaxial with the rotation axis of said shaft,
a rolling piston loosely fitted in said eccentric section and rolling inside said compression chamber,
a vane making contact with said rolling piston and dividing said compression chamber into a high-pressure side and a low-pressure side,
a main bearing for sealing one of side faces of said cylinder, that is, the side face on the side of said electric driving unit, and for journaling said main shaft of said shaft,
an auxiliary bearing for sealing the other side face of said cylinder and for journaling said auxiliary shaft of said shaft,
an oil supply spring secured to said auxiliary shaft, and
an oil supply tube accommodating said oil supply spring, the open end of which is disposed in said oil, wherein
said sliding member according to claim 12 is used for at least one of the members of said shaft, said cylinder, said rolling piston, said vane, said main bearing, said auxiliary bearing, said oil supply spring and said oil supply tube, having sliding faces.

16. A sliding member being characterized in that said sliding face modification material according to claim 10 is projected onto the sliding face of said sliding member made of a metallic material to form a coating layer in which molybdenum disulfide is solid-dissolved.
